(19) United States
(12) Patent Application Publication
(10) Pub. No.: US 2025/0058299 A1
(43) Pub. Date: Feb. 20, 2025

(54) Chromatographic Separation of Rare-Earth Elements

(71) Applicant: Rare Earth Technologies, Inc., Cincinnati, OH (US)

(72) Inventors: Dejene Kifle, Cincinnati, OH (US); Steve Levin, Cincinnati, OH (US)

(21) Appl. No.: 18/720,921

(22) PCT Filed: Dec. 19, 2022
(86) PCT No.: PCT/US2022/053411

§ 371 Date: Jun. 17, 2024

Related U.S. Application Data
(60) Provisional application No. 63/290,829, filed on Dec. 17, 2021.

(51) Int. Cl. B01J 20/287; B01D 15/16; B01D 15/24; B01D 15/32; B01D 15/42; B01J 20/10; B01J 20/28; B01J 20/32; C22B 11/00; C22B 59/00

(52) U.S. Cl. CPC B01J 20/287; B01D 15/166; B01D 15/24; B01D 15/325; B01D 15/424; B01J 20/103; B01J 20/28061; B01J 20/28083; B01J 20/3204; B01J 20/3248; C22B 11/04; C22B 59/00

(57) ABSTRACT

The present invention relates to development of stationary phases and preparation of extraction columns having substantially improved capacity (i.e., amount of material purified per single chromatographic run) for lab scale to industrial scale extraction chromatographic separation, from small scale to industrial scale, of rare earth elements (REEs) and the platinum group metals (PGMs). More specifically the invention relates to preparation of stationary phases and extraction columns for extraction of REEs or PGMs as a group from containing matrices of typical REE or PGM feedstock and separation and purification of individual REEs or PGMs from each other.

### CROSS REFERENCE TO RELATED APPLICATIONS

This application claims the benefit of U.S. Provisional Application No. 63/290,829, filed Dec. 17, 2021, the entirety of which is incorporated by reference herein.

### TECHNICAL FIELD

The present invention relates to stationary phases for extraction columns, preparing such stationary phases, extraction columns comprising such stationary phases, and methods for preparing such extraction columns. Such extraction columns have substantially improved capacity in terms of the amount of material purified per single chromatographic run. Inter alia, such extraction columns are useful for small scale and industrial scale extraction and chromatographic separation of rare earth elements (REEs) and/or Platinum Group Metals (PGMs).

More specifically the invention relates to preparation of stationary phases and extraction columns for: (i) extraction of REEs or PGMs as a group from typical feedstock containing REE and/or PGM; and (ii) separation and purification of individual REEs and/or PGMs from each other.

### BACKGROUND

The Rare Earth Elements (hereinafter abbreviated as REEs) include:
(i) the 15 elements from Atomic No. 57 to 71 in the Periodic Table of the elements and consist of: lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu), and
(ii) scandium (Atomic No. of 21) and yttrium (Atomic No. of 39).

The total number of REEs is thus 17. Of the 17 Rare Earth Elements only 16 have been of general interest, however, because promethium (Pm) has only radioactive isotopes. The REEs share many similar properties and occur together in geological deposits. Based on their properties, the REEs are generally divided into two groups: (1) light REEs (La−Gd); and (2) and heavy REEs (Tb−Lu). Although yttrium is one of the lightest REEs, it is grouped with heavy REEs because its physicochemical properties are similar heavier REEs.

In nature REEs are found in several minerals, typically as halides, carbonates, oxides, phosphates, and silicates. The most important sources for REEs are, however, the minerals bastnasite, monazite and xenotime. Typically, these minerals comprise several % by weight of REEs.

The Platinum Group Metals (PGMs) also known as precious metals and noble metals are rare, naturally occurring, metallic, chemical elements consisting of six elements: ruthenium (Ru), rhodium (Rh), palladium (Pd), osmium (Os), iridium (Ir) and platinum (Pt). The term “precious” refers to their high economic value, while the word “noble” signifies their chemical inertness.

PGMs are characterized by distinct physical and chemical properties from other base metals that exist in the same groups in the periodic system of the elements such as iron, cobalt, nickel and copper.

The PGMs are extremely scarce even compared to many of less abundant elements, such as REEs. The PGMs are prominently chalcophilic—that is sulfur-loving—and thus, are mainly found in sulfide minerals. Some of the PGMs also exist as minerals such as chromites, tellurides, selenides, arsenides and antimonides. While natural ores constitute as PGMs' primary sources, scrap or secondary materials are also their important sources. In particular, obsolete electronic scraps, spent automotive catalytic converters, spent batteries, used electric lamps, super alloys, jewelry scrap, and industrial wastes such as plating solutions and sludge constitute as potential PGM sources.

REEs and PGMs are groups of metals that play a key role in our modern world. They are crucial components of many emerging high-technology, new-energy, and defense industries because of their unique nuclear, metallurgical, chemical, catalytic, electrical, magnetic, and even optical properties.

Applications of REEs and PGMs depend not only on their characteristics, but also on their purity. Therefore, their market price increases significantly with purity. The sources of REEs and/or PGMs are minerals and secondary materials consisting of mixtures of several REEs and/or PGMs. To be used in high-tech applications, it is therefore necessary to separate them from their respective matrix components, and also from each other, at a high degree of purity.

But similar physicochemical properties render the separation of REEs and/or PGMs difficult and a challenging industrial problem.

Commercial production of individual REEs or individual PGMs start with the mining process where the respective ore materials are removed from the ground, crushed, and milled to appropriate particle sizes. This is followed by further processing aiming at isolating the minerals that contain the REEs and/or the PGMs. The processing steps for enrichment of the REE and/or PGM containing minerals typically comprise flotation and magnetic separation. Fairly pure concentrates of REE and/or PGM bearing minerals can be produced by this approach.

The respective ore concentrates are thereafter further refined to make concentrated solutions of REEs and/or PGMs. This is done by dissolving the rock material in suitable mineral acids such as hydrochloric acid (HCl), sulfuric acid (H₂SO₄), nitric acid (HNO₃), aqua regia (3HCl+1 HNO₃), or strong bases such as caustic soda (NaOH) or caustic potash (KOH). Dissolution often requires treatment at elevated temperatures. The resulting REE and/or PGM salts, typically chlorides, sulfates and nitrates, or REE and/or PGM hydroxides are thereafter separated into single elements, a challenging process due to similar physicochemical properties of the REEs and/or the PGMs.

Solvent extraction is the most common separation method, where an organic solvent containing a complexation agent (for example, an extractant) flows countercurrent to an aqueous stream containing the incoming salts of mixed REEs and/or PGMs. Complexes are formed between (the REE and/or PGM ions) and (the extractant molecules), and the REEs and/or the PGMs are separated based on the differences in the stability constants of the different REE-complexes and/or PGM-complexes.

Because solvent extraction requires hundreds or even thousands of extraction steps to achieve sufficient separation and purity, it poses a major processing disadvantage. In addition, each plant has to be custom made to a certain raw material and to a certain purity of the separated products. Solvent extraction consumes high amounts of process chemicals and associated health, safety, and environment (HSE) challenges.

Ion exchange chromatography or ligand assisted displacement chromatography is an alternative process that was extensively used before the solvent extraction process took over in the 1970s. Polyvinyl sulphonyl acid is typically used as strong cation-exchange material for the REEs and quaternary ammonium as strong anion exchanger for the PGMs. After loading, the REE or PGM ions are displaced by suitable ions in the presence of a ligand. The mixture must be passed through several columns to achieve high purity and requires a large amount of ligand solution and extremely longer displacement time up to several weeks to separate few grams of REEs or PGMs, resulting in low productivity. Moreover, the columns need to be regenerated with appropriate solution after each run, which leads to significantly higher production cost in the range of $40/kg, which makes uneconomical, thus unsuitable for large-scale productions.

Recently ligand assisted elution chromatography process for separation of metal ions, in particular the rare earth element (REEs) was published (Wang et al., 2020, U.S. Pat. No. 10,597,751 B2). The method is based on two sets of column system in combination with two sets of eluting ligand solutions. The first set of column comprises strong acid cation exchange resins and the second set of chromatographic columns comprises hydrous polyvalent metal oxide, such as TiO₂, ZrO₂, or SnO₂ and the elution ligands are EDTA and/or DTPA solutions. The proposed method is claimed to be capable of preparing substantially pure rare earth elements both in batch and continuous chromatographic modes and having reasonably high productivity and relatively lower production cost, thus suitable for large scale production.

However, the proposed process is relatively complex, where two sets of column systems and multiple solvents (for washing, elution and regeneration), some of which are very expensive chemicals are utilized. In addition, the method requires longer cycle time over 12 hours, which in fact is significantly shorter compared to ligand assisted displacement chromatography (i.e., ˜3 weeks), but still longer time. Furthermore, and according to data in the paper, the claimed lower production cost ($3.4-8.9/kg) is hugely dependent on and highly sensitive to the amount of elution ligand recycled and reused. Still, based on data in the paper, slight reduction in the percentage of recycled amount of elution ligand, for instance from 99% to 95%, results in about more than 265% increase in the production cost, which is significantly higher and risky.

Besides, the use of solutions of organic compounds in the process inevitably generates environmentally hostile waste that must be taken care of.

Extraction chromatography, which was originally developed in the 1960s with the advent of solvent extraction is another method used to achieve REE's separation. In extraction chromatography the separation column is impregnated with a chelating agent (often those used in solvent extraction) to increase the selectivity of the sorbent for the REE's or the PGMs.

The major limitation of extraction chromatography is its inherent low capacity due to small amount of extractant present in the extraction columns, which in turn leads to low productivity and extremely high resin cost (over 16,000/kg). As a result, the methods have never been further developed to industrial scale and limited only to analytical chromatography.

A summary of mining and enrichment of REE and PGM containing minerals may be found, among others, in www.mineralsUK.com, a book: Nature's building blocks an A-Z guide to the elements, John Emsley, Oxford University press, ISBN 0-19-8500340-7.

The existing REE and PGM separation and purification methods are technically inefficient, imposing adverse effect on the environment, characterized by complex and tedious processes, thus poorly suited for large scale productions, and/or require high investment and production costs. With the emergence and growing of new technologies dependent on unique properties of REEs and PGMs, the demand for high-purity individual REEs and PGMs from global high-tech and defense industries is growing. There is also an overwhelming pressure both internationally and domestically to reduce pollution levels created by the current REE and PGM separation and purification techniques. Therein lays a need for an innovative, efficient, cost effective and environmentally friendly REE and PGM separation method and system.

Attempts were made recently to improve the inherent limitation of extraction chromatography (i.e., low capacity of extraction columns) for potential preparative application. Different types of reversed phase silica materials were employed and extractants are physically impregnated using different impregnation techniques.

Wide pore (greater than 300 Å) reversed-phase (RP) silica showed better extractant retention capacity compared to narrow pore (100 Å) RP-silica (about 183%), despite having less than half of the surface area. Stated differently, the previous study advocates using wide-pore silica of greater than 300 Å pore size for extraction chromatography and rejects using less than 300 Å narrow-pore RP-silica.

The main reason for the lower extractant retention capacity or extractant density by narrow pore RP-silica was related to lower diffusion of the extractants due to highly viscous nature thereof, which hindered the extractant molecules to reach all available binding sites of narrow pore RP-silica. The use of organic solvent as diluent was not useful since it flashed out the extractant and led to even lower extractant density. In other words, the narrow-pore RP-silica was found to less than desirable compared to the wide-pore RP-silica of greater than 300 Å pore size.

The general goal of the present invention is to develop alternative methodology and industrial process for separation of REEs and PGMs from commercially available sources of mixed REE concentrates or PGM concentrates, respectively i.e., greener and cost-effective alternative to the above-mentioned methods, and to avoid or substantially reduce the technical, environmental and other problems associated with the technologies of the prior art.

One of the specific objectives of the invention was to develop stationary phase having substantially improved capacity (i.e., extractant density) for separation and purification of REEs and/or PGMs by extraction chromatography and solid-phase extraction.

Other objectives will be apparent to the skilled person by reading the present description.

### SUMMARY OF THE INVENTION

In certain aspects, the present invention relates to a stationary phase for chromatographic separation and/or purification of REEs and/or PGMs, said stationary phase comprising an extractant immobilized on a support, wherein: the support comprises a reverse-phase silica particles characterized by an average pore size less than 2,000 Å, the extractant comprises an organic compound with complex-forming property capable of retaining and separating REEs and/or PGMs by forming complexes of different stability constants with the different REEs and/or PGMs ions, wherein the extractant is impregnated into the support at a temperature in the range of 35° C. to 80° C., for example 70° C., and/or under an ultrasonic treatment step.

In some embodiments, the reverse-phase silica particles are characterized by an average pore size less than 300 Å and a surface area greater than 170 m²/g.

In some embodiments, the reverse-phase silica particles are characterized by an average pore size in the range of 50 Å to 150 Å, for example 60 Å, and a surface area in the range of 200-600 m²/g, for example 560 m²/g.

In some embodiments, the temperature is in the range of 50° C. to 60° C.

In some embodiments, the extractant comprises an organophosphorus compound, an amine, a quaternary ammonium salt, a sulfur bearing organic compound, or a combination thereof.

In some embodiments, the extractant comprises an organophosphorus compound, an amine, a quaternary ammonium salt, a sulfur bearing organic compound, or a combination thereof, with the general formula:

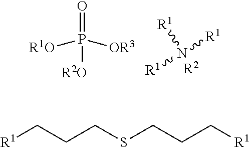

wherein: R¹ and R² independently are lipophilic hydrocarbons or modified hydrocarbons, selected from the group comprising C6-20 alkyl, C6-20 aryl, and R³ is H, C1-C6 alkyl, and C1-C6 aryl.

In some embodiments, the extractant comprises di-(2-ethylhexyl) phosphoric acid (DHEHP), di-(2,4,4-trimethylpentyl) phosphinic acid (H[TMPeP]) and 2-ethylhexyl, 2-ethylhexyl phosphonic acid (H[(EH)EHP]), aliquat-336 [N(CH₃)₄], dioctyl sulfide [S(CH₂)₂], or a combination thereof.

In certain aspects, the present invention relates to an extraction column for chromatographic separation and/or purification of REEs and/or PGMs, comprising a stationary phase as described above.

In certain aspects, the present invention relates to a method for preparing the stationary phase for chromatographic separation and/or purification of REEs and/or PGMs, comprising:
(i) providing a support that comprises reverse-phase silica particles characterized by an average pore size less than 2,000 Å,
(ii) impregnating at least one extractant into the reverse-phase silica particles of step 1, wherein the at least one extractant is an organic compound with complex-forming property capable of retaining and separating REEs and/or PGMs by forming complexes of different stability constants with the different REEs and/or PGMs ions,
   wherein the extractant is impregnated into the support under at least one of the two conditions, that of a temperature in the range of 50° C. to 80° C., for example 70° C.; and that of an ultrasonic treatment step. In some embodiments, the temperature is in the range of 50° C. to 60° C.

In some embodiments, the reverse-phase silica particles are characterized by an average pore size less than 300 Å and a surface area greater than 170 m²/g.

In some embodiments, the reverse-phase silica particles are characterized by an average pore size in the range of 50 Å to 150 Å, for example 60 Å, and a surface area in the range of 200-600 m²/g, for example 560 m²/g.

In some embodiments, the extractant comprises an organophosphorus compound, an amine, a quaternary ammonium salt, a sulfur bearing organic compound, or combinations thereof.

In some embodiments, the extractant comprises an organophosphorus compound, an amine, a quaternary ammonium salt, a sulfur bearing organic compound, or combinations thereof, with the general formula:

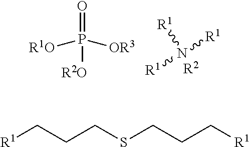

wherein: R¹ and R² independently are lipophilic hydrocarbons or modified hydrocarbons, selected from the group comprising C6-20 alkyl, C6-20 aryl, and R³ is H, C1-C6 alkyl, and C1-C6 aryl.

In some embodiments, the extractant comprises di-(2-ethylhexyl) phosphoric acid (DHEHP), di-(2,4,4-trimethylpentyl) phosphinic acid (H[TMPeP]) and 2-ethylhexyl, 2-ethylhexyl phosphonic acid (H[(EH)EHP]), aliquat-336 [N(CH₃)₄], dioctyl sulfide [S(CH₂)₂], or a combination thereof.

In certain aspects, the present invention relates to a method for separating and/or purifying REEs and/or PGMs, from an aqueous solution comprising REEs and/or PGMs, said method comprising the steps of:
(a) providing the extraction column as recited herein;
(b) loading the aqueous solution comprising REEs and/or PGMs onto the extraction column;
(c) using an eluent mode to separate REEs and/or PGMs; and
(d) eluting the separated REES and/or PGMs from the extraction column.

In some embodiments, the eluent mode is an eluent concentration mode and/or an eluent flow-rate gradient mode, and optionally, the eluting step is performed by:
(i) an isocratic concentration of an eluent mineral acid in said aqueous solution,
(ii) a linear gradient concentration of said eluent mineral acid in said aqueous solution, or
(iii) a step-wise gradient of concentration of said eluent mineral acid in said aqueous solution.

In some embodiments, the method further comprises at least one of the following steps:
(e) collecting a fraction of eluate comprising the REEs and/or PGMs;
(f) up-concentrating the eluted the REEs and/or PGMs fraction; and
(g) recovering the eluent mineral acid and water.

In some embodiments of the method, the elution and collection of fractions in steps d and e are controlled in a manner to collect the REEs and/or PGMs having similar retention capacities on a given extraction column from the one or more than one extraction column.

In some embodiments, the REEs and/or PGMs solution loaded onto the column has an acid matrix allowing the REEs and/or PGMs to be quantitatively retained by the given column.

In some embodiments, the quantitatively retained REEs and/or PGMs are REEs and are eluted with an eluent having increasing acid concentration and/or eluent flow-rate to first elute a light-REE group, thereafter a SEG-REE group, and thereafter a heavy REE+Y group.

In some embodiments of the methods as contemplated herein:
(i) the light-REE group is completely absent or comprises at least one of La, Pr, and Nd,
(ii) the SEG-REE group is completely absent or comprises at least one of Sm, Eu, and Gd; and
(iii) the heavy REE+Y group is completely absent or comprises at least one of Tb, Dy, Ho, Er, Tm, Yb, Lu, and Y;
and at least one of the three groups from (i), (ii), and (iii) is present.

In some embodiments, the REES and/or PGMs comprises PGMs, wherein said PGMs are quantitatively retained and are eluted with an eluent having increasing acid concentration and/or eluent flow-rate, wherein:
(i) a primary group PGMs comprising at least one of Pd and Pt is eluted first and,
(ii) a secondary group PGMs comprising at least one of Rh, Ru and Ir is eluted second.

In some embodiments of the methods, the elution and collection of fractions in step d and/or e is controlled to collect substantially pure fractions of individual metals from the REEs and/or PGMs.

In some embodiments, fractions containing group of REEs, individual REEs, group of PGMs, or PGMs are collected, and concentrated to recover eluent by distillation, ion-exchange, membrane filtration, centrifugation, solvent extraction, evaporation, azeotropic distillation, liquid-liquid extraction, or a combination thereof.

In some embodiments, one or more of the concentrated fractions are converted to insoluble salts, oxides of metals, which are individually collected and dried.

In some embodiments, the elution is performed under a pressure between 50 and 100 bar.

In some embodiments, the aqueous solution is acidic.

In some embodiments, the quantitatively retained REEs are eluted with an eluent having increasing acid concentration and or eluent flow-rate to first elute a light-REE group mainly comprising La, Pr and Nd and, thereafter a SEG-REE group comprising Sm, Eu and Gd and a heavy REE+Y group mainly comprising Tb, Dy, Ho, Er, Tm, Yb, Lu and Y.

In some embodiments, the quantitatively retained PGMs are eluted with an eluent having increasing acid concentration and or eluent flow-rate to first elute a primary group PGMs comprising Pd and Pt and, thereafter a secondary group PGMs comprising Rh, Ru and Ir.

In some embodiments, the elution and collection of fractions is controlled to collect substantially pure fractions of individual REEs or PGMs.

In certain aspects, the present invention relates to a method for industrial separation and purification of individual REEs and/or PGMs from an aqueous mixed REEs and/or PGMs solution, wherein, from an incoming solution comprising mixed REEs and/or PGMs:
(i) the REEs and/or PGMs are first separated into sub-groups, of REEs and PGMs, by the method as recited herein, and
(ii) one or more of the sub-groups of REEs and/or PGMs thereafter are separated as described herein.

### BRIEF DESCRIPTION OF DRAWINGS

### Core Inventions

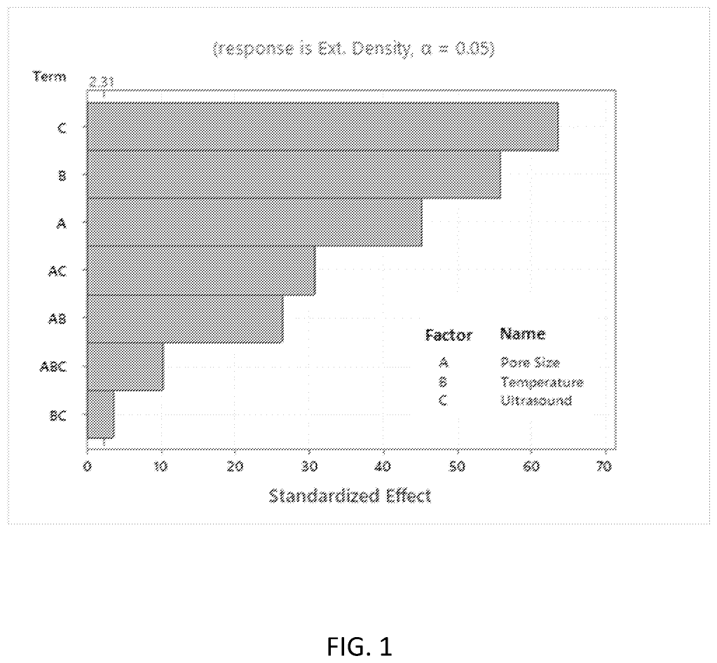

FIG. 1 is a Pareto chart of the standardized effect showing the significance of the experimental variables. Factors above the reference line of 2.31 have significant effect on the response. The extent of the influence is proportional to the length of the respective bars.

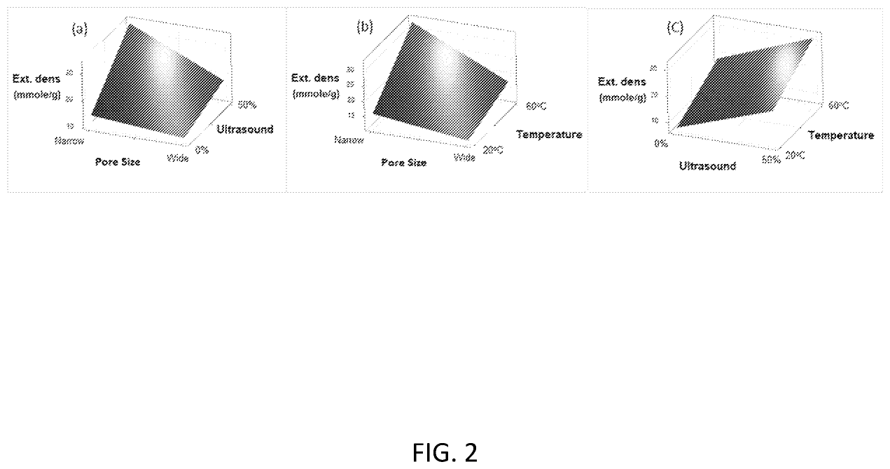

FIG. 2 depicts response surfaces from the factorial design showing the influence of (a) pore size and ultrasound (b) pore size and temperature, and (c) temperature and ultrasound on the extractant density of the stationary phase.

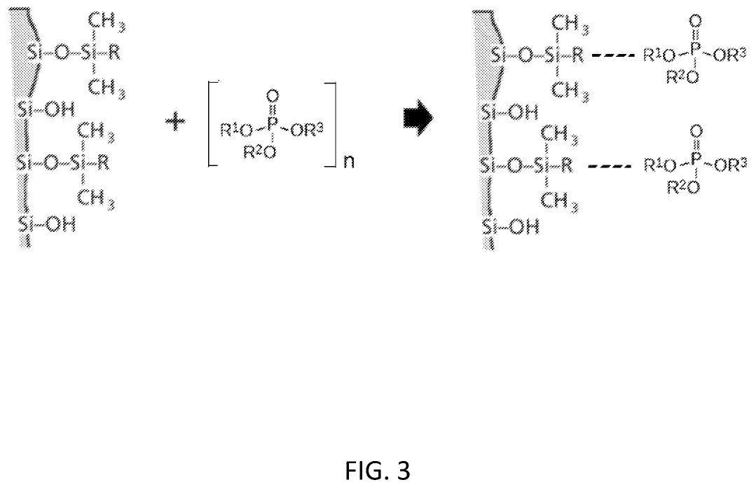

FIG. 3 is an illustration of immobilization of organophosphorus compound as a model extractant on porous RP-silica particle according to the invention.

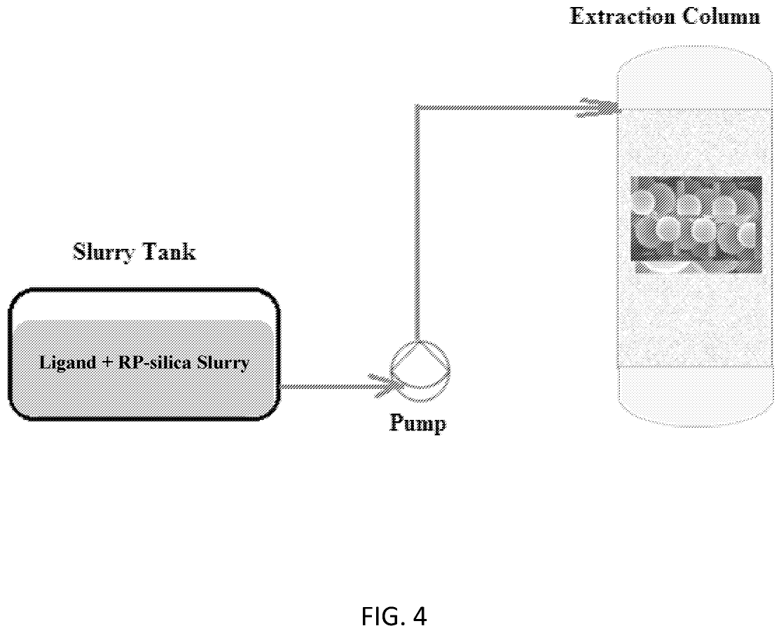

FIG. 4 is a simplified diagram illustrating extraction column packing method according to the invention.

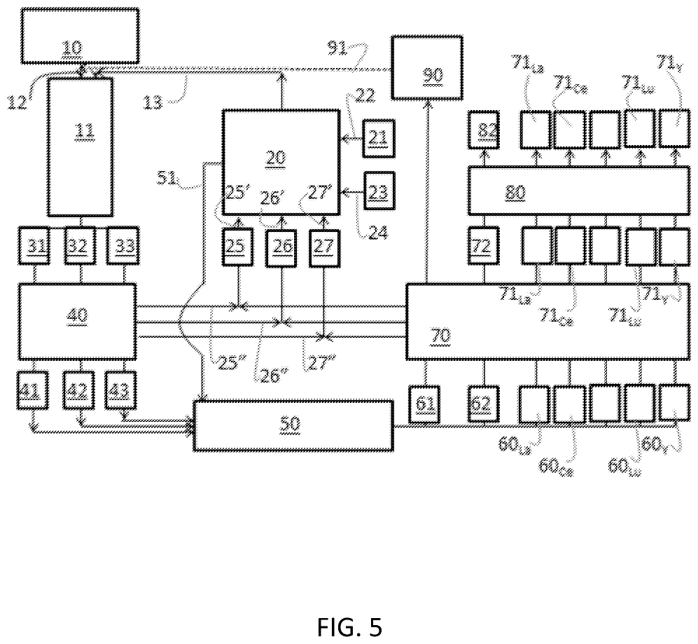

FIG. 5 is a simplified flow diagram illustrating a process according to the invention.

### Lab-Scale Tests

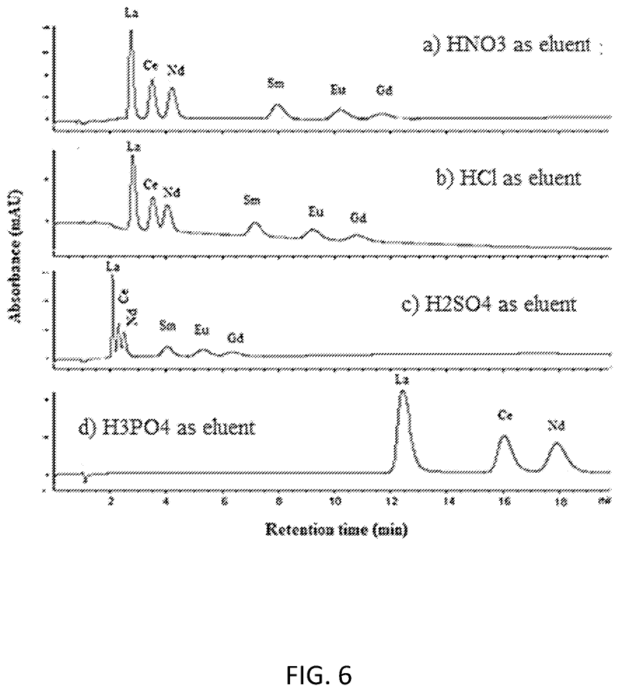

FIG. 6 illustrates elution profile of lighter REEs obtained after elution with different mineral acids under similar conditions using extraction chromatography.

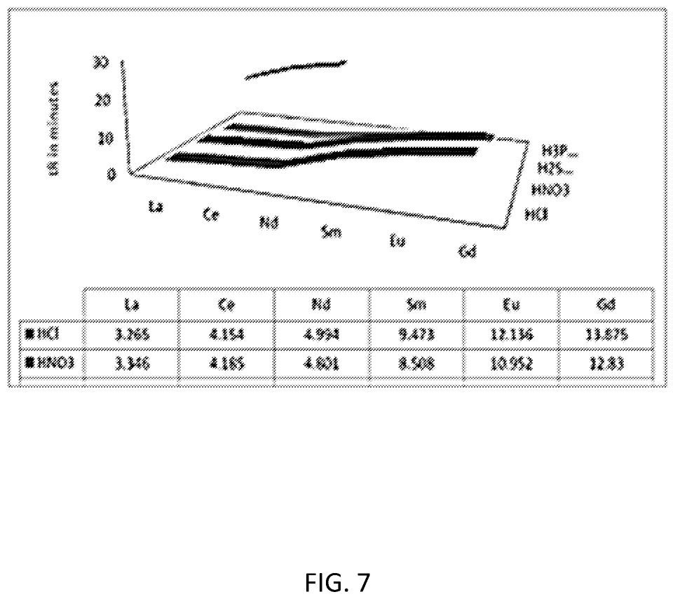

FIG. 7 illustrates retention times (Rt) of REEs obtained after elution with different mineral acids under similar conditions using extraction chromatography.

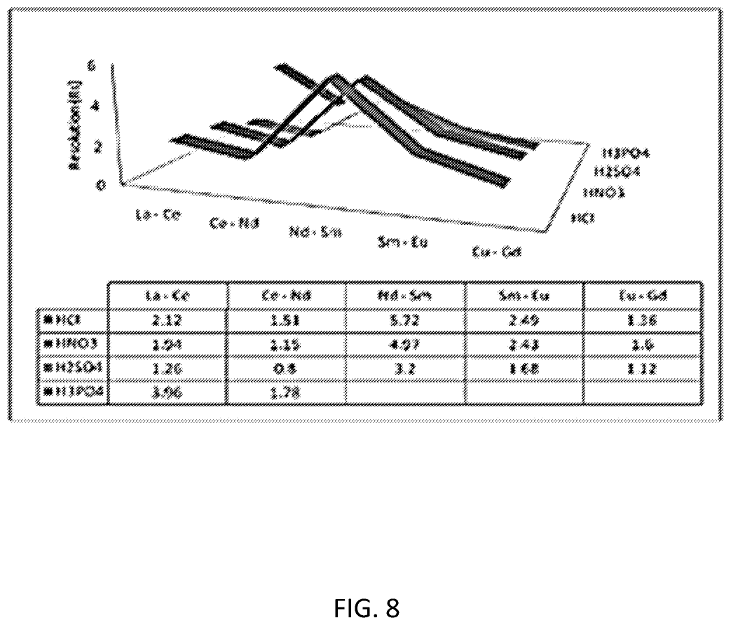

FIG. 8 illustrates resolution (Rs) of REEs after elution with different acids under similar conditions using extraction chromatography.

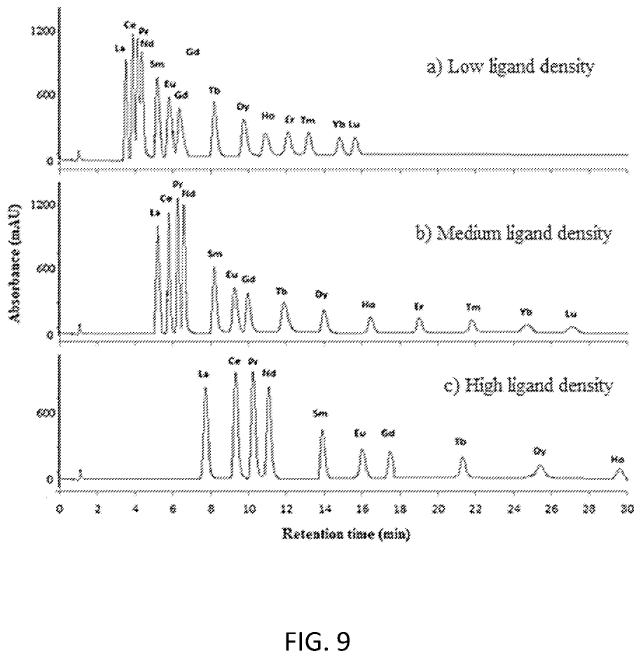

FIG. 9 illustrates elution profile of REEs obtained using extraction columns of different ligand densities under similar chromatographic conditions.

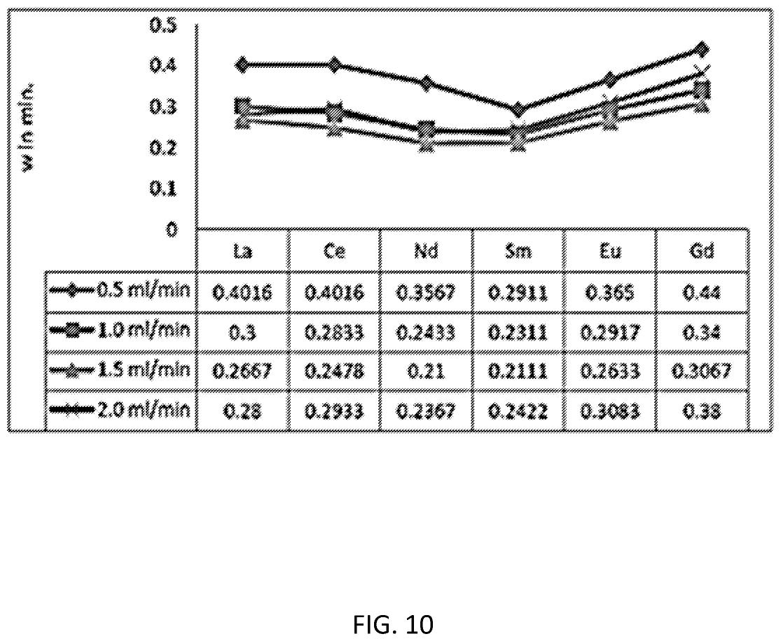

FIG. 10 illustrates peak width (w) of REEs as a function of eluent flow rate (u).

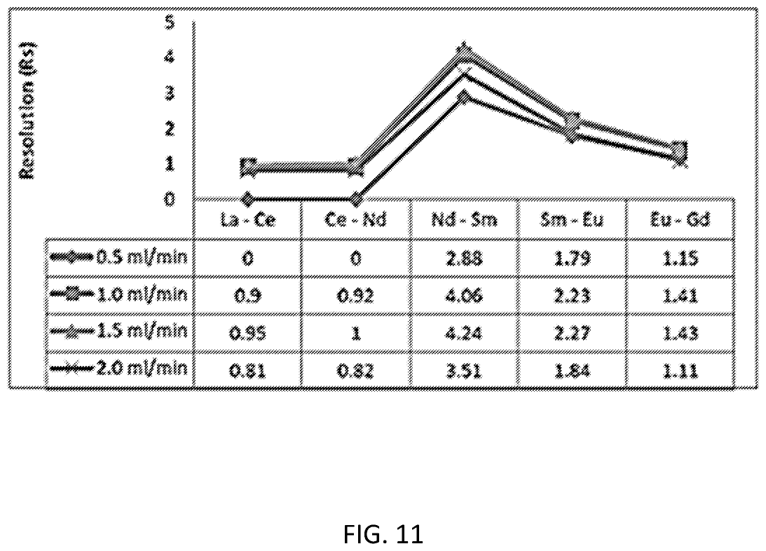

FIG. 11 is showing resolution (Rs) between adjacent REEs as a function of eluent flow rate (u).

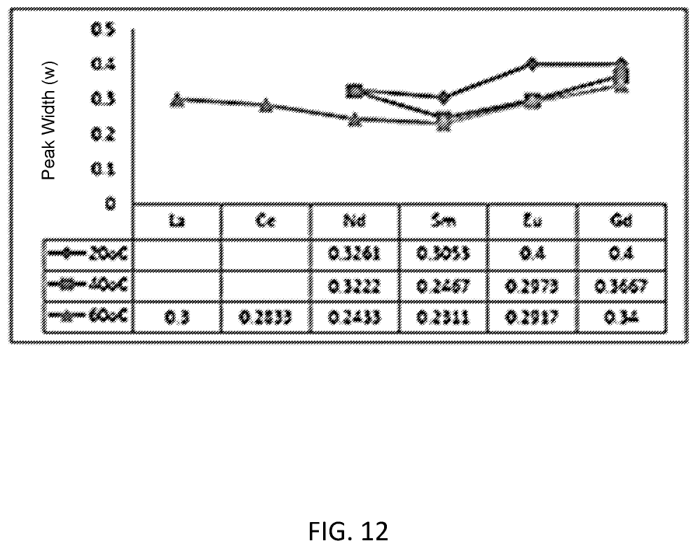

FIG. 12 shows peak width (w) of REEs as a function of temperature (T).

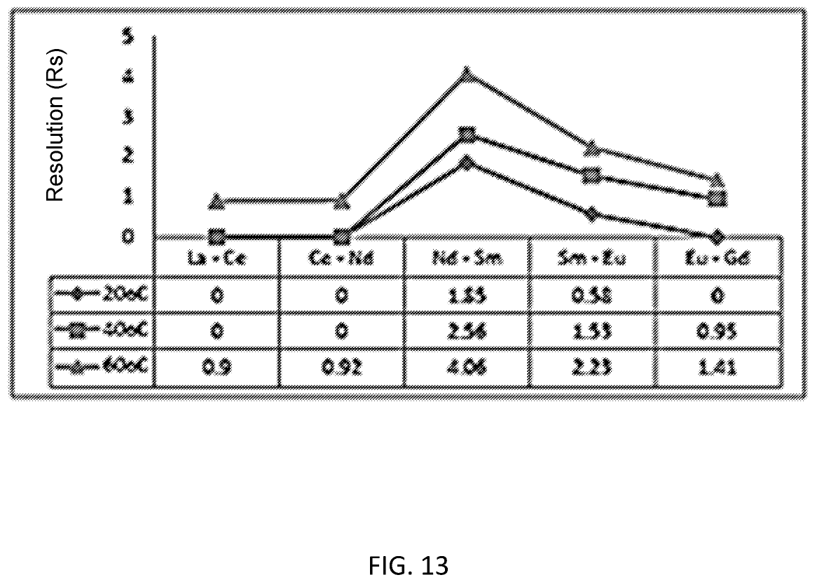

FIG. 13 shows resolution (Rs) of REEs as a function of temperature (T).

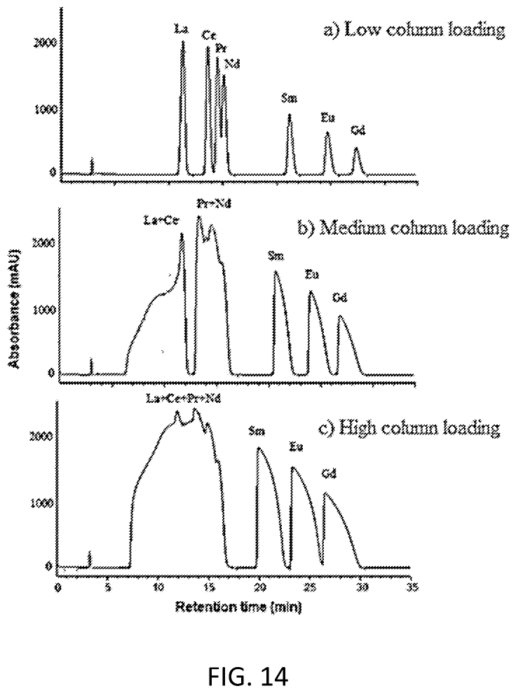

FIG. 14 is a chromatogram illustrating peak shapes of REEs at high REE loading.

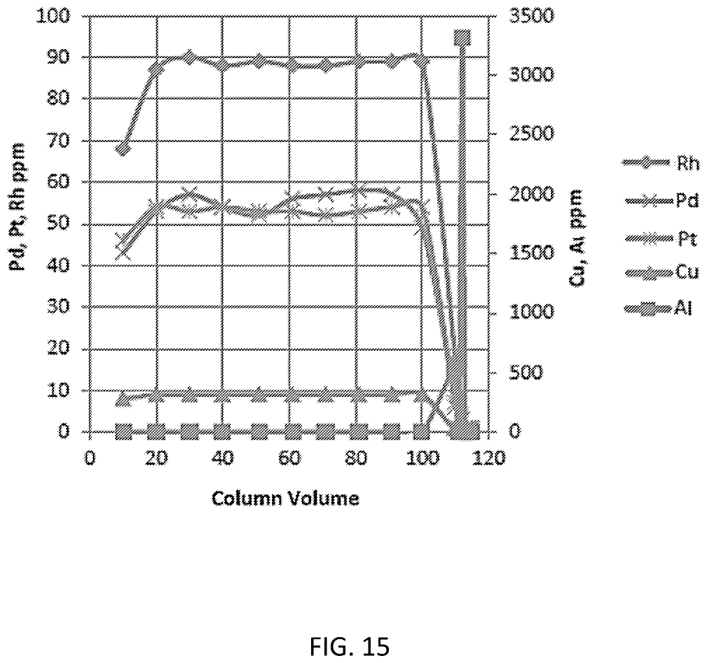

FIG. 15 shows separation of PGMs as a group from accompanying base metals using Aliquat-336 extraction column.

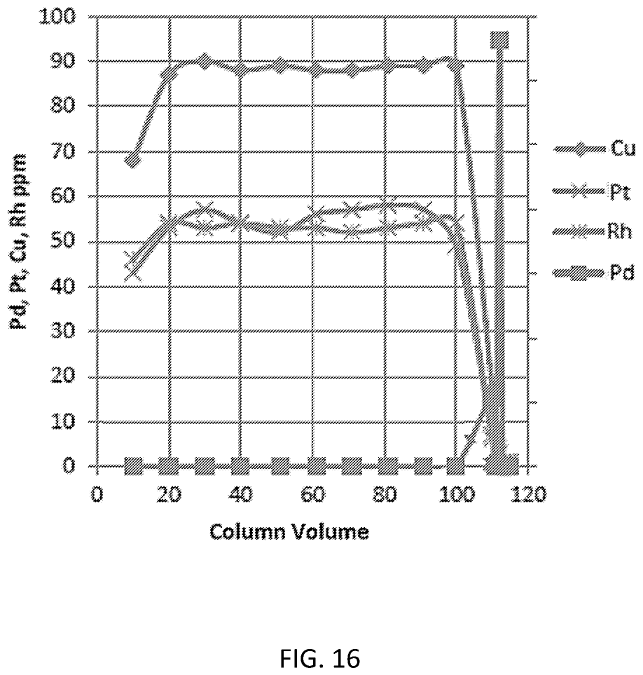

FIG. 16 shows individual separation of Pd from other PGMs using di-octyl sulfide (DOS) extraction column.

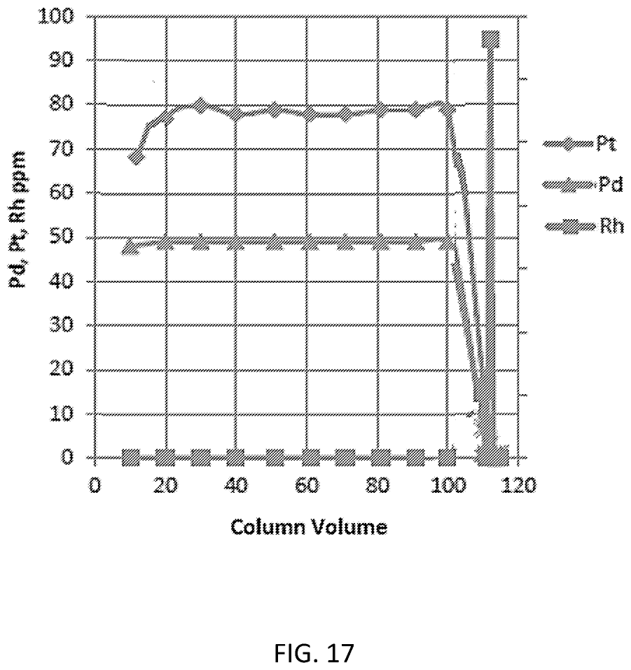

FIG. 17 shows individual separation of Rh from the other PGMs using di-ethyl tri-amine (DETA) extraction column.

### Pilot-Scale Tests

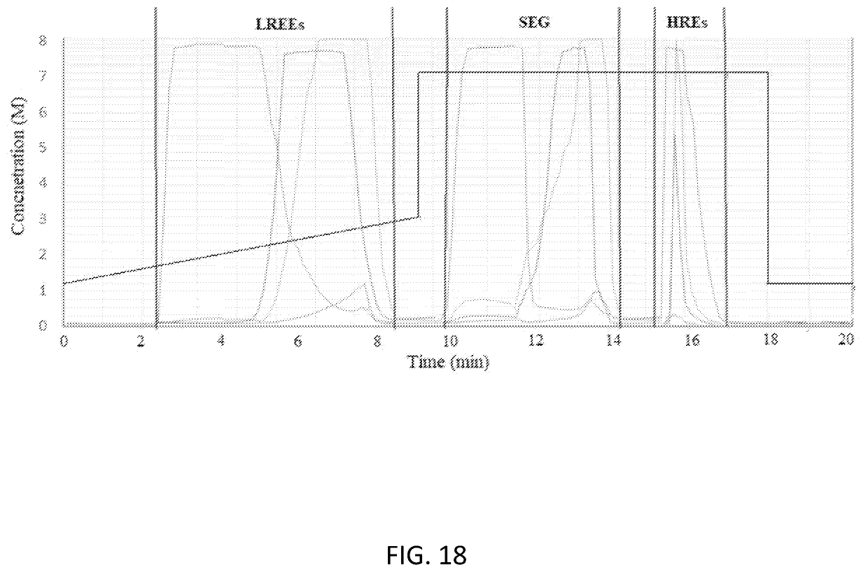

FIG. 18: is a chromatogram showing group separation of REEs from pilot scale testing using extraction chromatography.

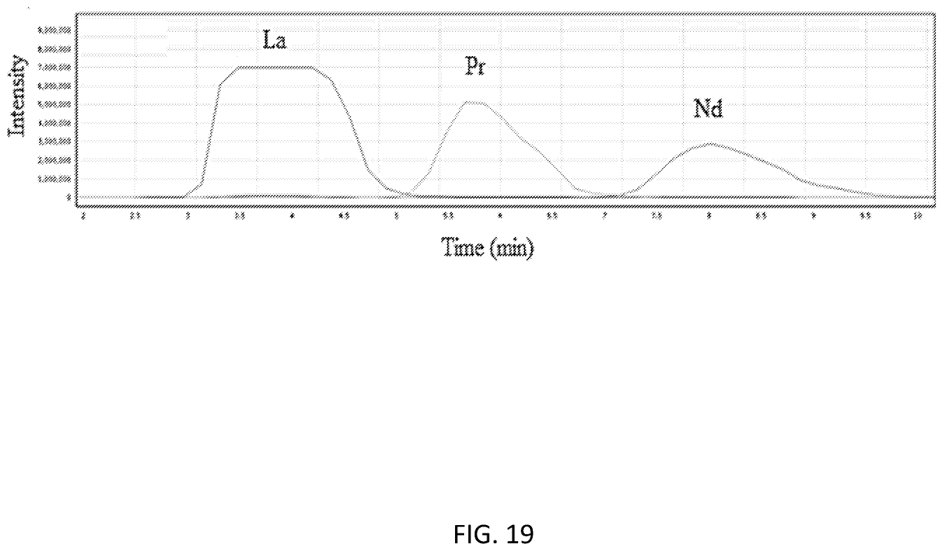

FIG. 19: is a chromatogram showing individual separation of lighter REEs from pilot scale testing using extraction chromatography.

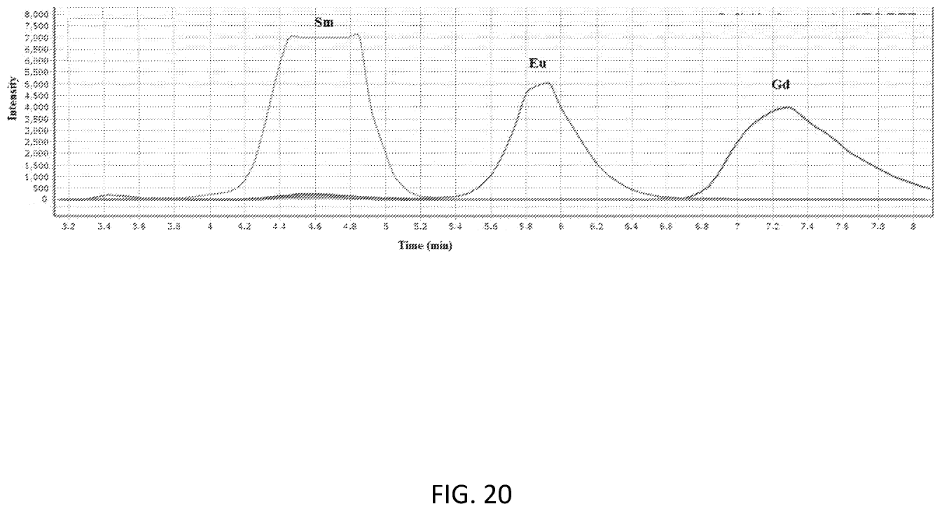

FIG. 20: is a chromatogram showing individual separation of SEG REEs from pilot scale testing using extraction chromatography.

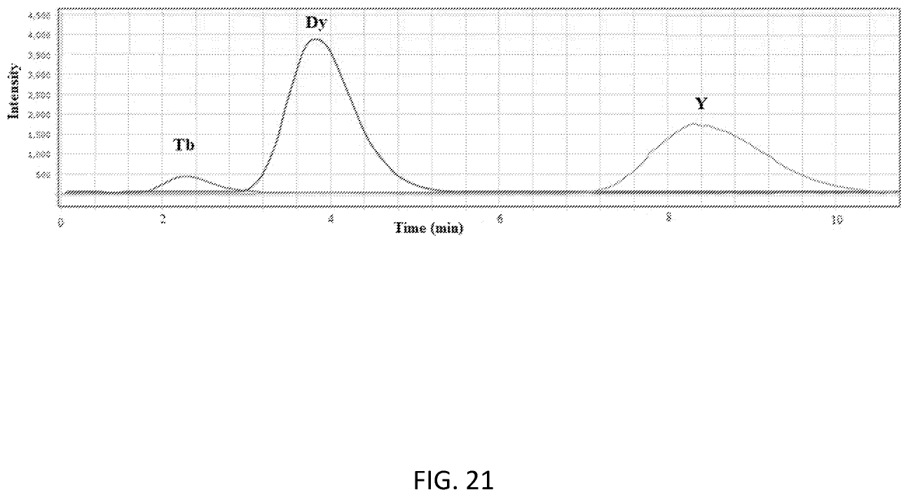

FIG. 21: is a chromatogram showing individual separation of heavy REEs from pilot scale testing using extraction chromatography.

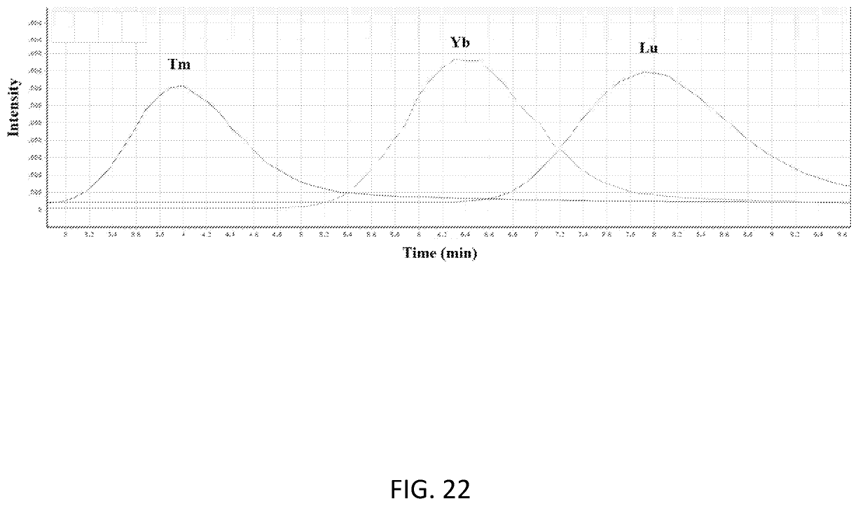

FIG. 22: is a chromatogram showing individual separation of heavy REEs+Y from pilot scale testing using extraction chromatography.

### DETAILED DESCRIPTION OF THE FIRST ASPECT OF THE INVENTION

In the context of the present description, all publications, patent applications, patents and other references mentioned herein, if not otherwise indicated, are explicitly incorporated by reference herein in their entirety for all purposes as if fully set forth.

Unless otherwise defined, all technical and scientific terms used herein have the same meaning as commonly understood by one of ordinary skill in the art to which this disclosure belongs. In case of conflict, the present specification, including definitions, will control.

Except where expressly noted, trademarks are shown in upper case.

Unless stated otherwise, all percentages, parts, ratios, etc., are by weight.

Unless stated otherwise, pressures expressed in psi units would be gauge, and pressures expressed in kPa units would be absolute. Pressure differences, however, are expressed as absolute (for example, pressure 1 is 25 psi higher than pressure 2).

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

When the term “about” is used, it is used to mean a certain effect or result can be obtained within a certain tolerance, and the skilled person knows how to obtain the tolerance. When the term “about” is used in describing a value or an end-point of a range, the disclosure should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus.

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Optional additives as defined herein, at a level that is appropriate for such additives, and minor impurities are not excluded from a composition by the term “consisting essentially of”.

Further, unless expressly stated to the contrary, “or” and “and/or” refers to an inclusive and not to an exclusive. For example, a condition A or B, or A and/or B, is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise.

### Definitions

By “Rare Earth Elements” is meant a set of seventeen metallic elements. These include: (i) the fifteen lanthanide group the elements from Atomic No. 57 to 71 in the Periodic Table of the Elements, namely: lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu); and (ii) scandium (Atomic No. of 21) and yttrium (Atomic No. of 39).

By “Platinum Group Metals” is meant the six noble precious metallic elements, namely: platinum, palladium, rhodium, ruthenium, iridium, and osmium.

By “Pore Size” is meant the mean or average pore size of the pores of the support material that is used for preparing the stationary phase.

By “Reversed-Phase Silica” is meant a stationary phase used in liquid chromatography that has long carbon chains bonded to silica particles that do not have a dominant polar character.

By “Extractant Density” is meant the amount of extractant retained by one gram of solid support, in this case reversed-phase silica particle.

Reverse phase silica particles, are commercially available from different sources, and are commonly used as stationary phase in chromatography, and are prepared by modifying silica particles which have a polar surface, by binding alkyl groups to the surface thereof as follows:

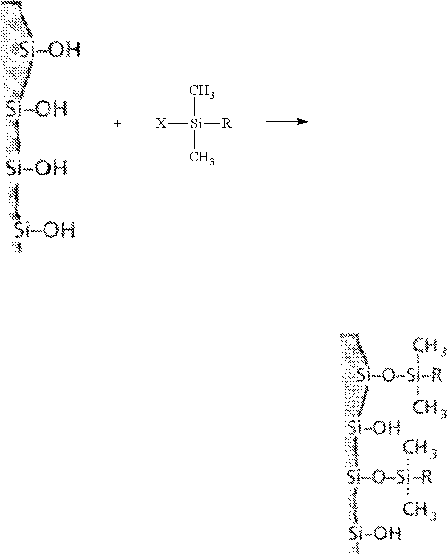

where R typically is an alkyl chain of 4, 8 or 18 C atoms.

Such modified silica particles are commonly used for chromatographic separation of compounds having different affinity for the modified non-polar particle surface. The modified silica particles may also be used for immobilization of ligands having non-polar ends to these modified particles by means of van der Waals binding.

According to the present invention, the capacity of an extraction column, that is, the amount of material purified in a single chromatographic cycle, is increased by increasing the amount of extractant in the extraction column. The latter may be described as extractant density, that is, the amount of extractant retained by a gram of solid support, in this case revered-phase silica particle.

Due to its hydrophilic or lyophobic nature, native silica particle does not retain extractants, which are generally hydrophobic. The polar surface of native silica material is modified and made hydrophobic by binding hydrocarbons (R) to the surface thereof as follows, where R typically is an alkyl chain of 4, 8 or 18 C atoms. This material is called reversed-phase (RP) silica referring to its non-polar surface as opposed to native silica, which is also known as normal phase (NP) silica.

In one embodiment, this invention relates to separating and purifying REEs and/or PGMs using extraction chromatography. The chromatographic columns are prepared by loading with stationary phase that is reverse-phase silica. The RP-silica of the present invention has extractants impregnated and immobilized in their porous surface. The impregnation is performed under a two-prong driving force: that of high temperature and ultrasonication. As a result, the extractant concentration in the RP-silica is much higher, which directly correlates to separation efficiency of the REEs and/or PGMs. Primary source and secondary source of REEs and/or PGMs can be treated by the column and process of the present invention.

Depending on the specific applications, the presently preferred extractants are dialkyl phosphoric acid such as di-(2-ethylhexyl) phosphoric acid (DHEHP); di-(2,4,4-trimethylpentyl) phosphonic acid (H[TMPeP]); and 2-ethylhexyl 2-ethylhexyl phosphonic acid (H[(EH)EHP]); aliquat-336 [N(CH₃)₄]; dioctyl sulfide [S(CH₂)₂]; and 2-ethylhexyl phosphonic acid mono-2-ethylhexyl ester.

In one embodiment, the extractants include one or more of di-(2-ethylhexyl)phosphoric acid in dilute H₂SO₄/HCl/HNO₃, 2-ethylhexyl 2-ethylhexyl phosphonic acid, tributyl phosphate, di(2-ethylhexyl)phosphoric acid (DEHPA), 2-ethyl-hexyl-2-ethyl-hexyl-phosphoric acid, tri-butyl phosphate, versatic acid, and/or versatic acid 10.

In one embodiment, the extractants are one or more of bis(2,4,4-trimethylpentyl)phosphinic acid, bis(2-ethylhexyl)phosphinic acid, bis(2-ethylhexyl)phosphonic acid, phenylphosphonic acid, 2-ethylhexylphosphonic acid, mono-2-ethylhexyl ester, and/or their salts.

In another embodiment, the extractants are one or more of 2-ethylhexyl phosphonic acid mono-2-ethylhexyl ester trialkyl methyl ammonium or di-2-ethylhexyl phosphoric acid trialkyl methyl ammonium, 2-ethylhexyl phosphonic acid mono-2-ethylhexyl ester trialkyl methyl ammonium ([A336][P507]), di-2-ethylhexyl phosphoric acid, trialkyl methyl ammonium ([A336][P204]), and/or cations and anions in a quaternary ammonium ionic liquid extractant, that is, 2˜ethylhexyl phosphonic acid mono-2-ethylhexyl ester trialkyl methyl ammonium and di-2-ethylhexyl phosphoric acid trialkyl methyl ammonium.

In one embodiment, the extractant are one or more of di-(2-ethylhexyl) phosphoric acid (HDEHP), mono(2-ethylhexyl)2-ethylhexyl phosphonate (HEH/EHP), bis(2,4,4-trimethylpentyl)monothiophosphinic acid), octyl phenyl phosphate (OPAP), 2-ethylhexylphosphonic acid mono-2-ethylhexyl ester (PC88A) and optionally toluene, tributyl phosphate, di-isoamylmethyl phosphonate, 7-(4-ethyl-1-methyloctyl)-8-hydroxyquinoline, di-(2-ethylhexyl) phosphinic acid, bis(2,4,4-trimethylpentyl) phosphinic acid, 8-hydroxyquinoline, (2-ethylhexyl)phosphonic acid, and/or mixtures thereof.

Such extractant solvents are described in U.S. Pat. No. 9,752,212, and U.S. Pat. Pub, No. 2015/0104361, which are fully incorporated by reference herein.

Reversed phase (RP) silica particles, are commercially available from different sources, and are commonly used by pharmaceutical industry as stationary phase in reverse-phase liquid chromatography.

For the present invention, the reversed-phase silica particles that can be used have an average pore size in the range of from about 50 Å to about 2000 Å. In one embodiment, the average pore size is any number selected from the following numbers, or a number within the range defined by any two numbers below, including the endpoints of such range, as measured in Å: 50, 60, 70, 80, 90, 100, 120, 140, 160, 180, 200, 220, 240, 260, 280, 300, 320, 340, 360, 380, 400, 500, 600, 700, 800, 900, 1000, 1100, 1200, 1300, 1400, 1500, 1600, 1700, 1800, 1900, and 2000.

For the present invention, the reversed-phase silica particles that can be used surface area in the range of from about 20 m²/g to about 600 m²/g. In one embodiment, the surface area is any number selected from the following numbers, or a number within the range defined by any two numbers below, including the endpoints of such range, as measured in m²/g:

20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, and 600.

In a preferred embodiment, the surface area is in the range of from about 170 m²/g to about 560 m²/g.

For the present invention, the impregnation of the extractant into the reversed-phase silica is performed under ultrasonic treatment. In one embodiment, the ultrasonic treatment is combined with an elevated temperature for impregnation. The ultrasonic treatment can be continuous or discrete. It can also be cyclical, or random. The ultrasonic power output is in the range of 0-100%. Stated differently, the power output is any number from the listing below, including a number that is within a range defined by any two numbers below, including the endpoints of such range, as measured in %:

0, 10, 20, 30, 40, 50, 60, 70, 80, 90, and 100.

In a preferred embodiment, the power output is in the range 40-50%.

In one embodiment, the temperature of impregnation is in the range of ambient to 80° C. In another embodiment, the temperature is any number from that provided below, including a number that is within a range defined by any two numbers below, including the endpoints of such range, as measured in ° C.:

20, 25, 30, 35, 40, 45, 50, 55, 60, 65, 70, 75, and 80.

In a preferred embodiment, the temperature range is from about 50° C. to about 60° C.

In one embodiment, for impregnation of the extractant ultrasonic treatment was used.

In another embodiment, the ultrasonic frequency range used is in the range of from 20 kHz to about 100 kHz, and that works best is 40 kHz to 60 kHz.

In one embodiment, the ultrasonic frequency ranges from 20 kHz to 100 kHz. Stated differently, the ultrasonic frequency is any number from the listing below, including a number that is within a range defined by any two numbers below, including the endpoints of such range, as measured in kHz:

20, 25, 30, 35, 40, 45, 50, 55, 60, 65, 70, 75, 80, 85, 90, 95, and 100.

In extraction chromatography (ExC) organic compounds with complex-forming property (extractants) are immobilized on inert solid support and used as a stationary phase. Equation-1 (Eq-1) shows the general formula responsible for separation of REEs by ExC using extractant (designated as HLn) as stationary phase and mineral acid as eluent.

$$R {E}_{( a q )}^{⋆ 3} + 3 {( HLn )}_{( org )} ↔ R {E ( Ln )}_{3 ( o r g )} + 3 {H}_{( a q )}^{⋆} \qquad ( Eq - 1 )$$

The extractant is considered as mono-ionizable molecule and three molecules are bound with one REE cation by breaking hydrogen bonds and via the oxygen atoms formerly bound by the exchanged protons.

The equilibrium constant (K) of Eq-1, which is also known as the stability constant of the metal-extractant complex is described by Equation-2 (Eq-2).

$$K = {[ {RE ( Ln )}_{3} ]}_{org} * {[ {H}^{+} ]}_{a q}^{3} {/ [ {RE}^{3 +} ]}_{aq} * {[ HLn ]}_{o r g}^{3} \qquad ( Eq - 2 )$$

The distribution ratio (D), which is the measure of distribution of a solute in two immiscible solvents, can be calculated by dividing the total concentration of the extracted metal ion in the organic phase by the total concentration in the aqueous phase. In column extraction chromatography, this is the same as the ratio of molar concentration of the metal ion in the stationary phase (i.e., the extractant impregnated on support) to molar concentration of the metal ion in the mobile phase (the eluent acid).

$$D = {[ {RE ( Ln )}_{3} ]}_{org} {/ [ {RE}^{3 +} ]}_{a q} \qquad ( Eq - 3 )$$

Dividing Eq-3 by Eq-2 and rearranging gives Eq-4

$$D = K * {[ HLn ]}_{org}^{3} {/ [ {H}^{+} ]}_{aq}^{3} \qquad ( Eq - 4 )$$

The distribution ratio (D) may also be mathematically related to certain column parameters, such as retention volume (Vr) and volume of the stationary phase (Vs) as shown in Eq-5.

$$D = Vr / Vs \qquad ( Eq - 5 )$$

Assuming that retention volume (Vr) is equal to retention time (tR) and combining Eq-5 with Eq-4, results in Eq-6

$$tR / Vs = K * {[ HLn ]}_{org}^{3} {/ [ {H}^{+} ]}_{a q}^{3} \qquad ( Eq - 6 )$$

Taking the log value of the equations and after rearranging, it takes the form

$$log tR = 3 log [ HLn ] - 3 log [ {H}^{+} ] + log Vs + K \qquad ( Eq - 7 )$$

Eq-7 shows that the retention time (tR), which is also known as capacity factor has a direct third-order dependence on the molar concentration of the extractant and direct first-order dependence on the volume of the stationary phase (Vs). This clearly shows that the greater the amount of extractant on the column the greater is the column capacity in terms of sample throughput or sample load, in other words, greater production capacity.

Impregnation behaviors of bulk RP-silica materials and pre-packed HPLC columns based on batch and flow-through impregnation techniques have been previously investigated, using di-(2-ethylhexyl) phosphoric acid (HDEHP) and dioctylsulfide (DOS), which are commonly used in separation of REEs and extraction of PGMs, respectively, as model extractants.

From preliminary experiments, it was previously known that the capacity of the extraction column (i.e., the extractant density on the RP-silica support) is mainly influenced by the diffusion of the extractant in the pores of porous RP-silica particles and nature the RP-silica material, particularly pore size and surface area thereof.

The present invention is based on further experiments studying the effect of pore size (surface area) of RP-silica particles and driving forces to enhance diffusion of extractants, such as temperature and ultrasound on the capacity of the stationary phase (i.e., the extractant density).

### Experimental

### Extractant and Bulk Silica Materials

Di-(2-ethylhexyl) phosphoric acid (HDEHP) of 99% purity was procured from ALFA AESAR® (Karlsruhe, Germany), and di-octyl sulfide (DOS) of 99% purity was procured from Sigma Aldrich (Germany). Suprapur 65% HNO₃ was procured from MERCK® (Darmstadt, Germany). Single-element standard La solution in HNO₃ matrix was obtained from Teknolab A/S (Kolbotn, Norway). Deionized water obtained from a MILLIPORE® Milli-Q system was used throughout. Bulk reversed-phase silica materials Luna 15 μm, C18-100; and Jupiter 15 μm, C18-300 (from now on called Narrow pore and Wide pore, respectively) were supplied by PHENOMENEX® (Torrance, CA, USA). Particle and bonded phase specifications of RP-silica bulk materials are given in Table-1.

TABLE 1
Specification of RP-silica and Bare silica particles used in the experiment.

| | Particle Size | Pore Size | Surface Area | Total carbon | Surface Cover |
|---|---|---|---|---|---|
| RP-Silica | (μm) | (Å) | (m²/g) | (%) | (μmole/g) |
| Narrow Pore | 12.6 ± 1.5 | 100 ± 10 | 400 ± 30 | 13.5 ± 0.7 | 5.0 ± 0.6 |
| Wide Pore | 12.3 ± 0.7 | 320 ± 40 | 170 ± 30 | 13.0 ± 0.7 | 5.1 ± 0.5 |

### Instrumentation

The HPLC system was AGILENT® 1200 (USA) consisting of an auto-sampler, a quaternary pump solvent delivery system and an auxiliary isocratic pump. Microwave Plasma atomic emission spectrometer (MP-AES) from AGILENT®, USA was coupled to the HPLC system and used as detector. For the ultrasound reactions, a FISHER® Sonic Dismembrator Model 300 (Artek Systems Corporation, Farmingdale, NY, USA) was used.

### Software & Data Handling

Chemstation software (AGILENT® Technologies, USA) was used for instrument control, data acquisition and reporting. MINITAB® release 19 statistical software (MINITAB® Inc, USA, 2019) was used to build the experimental design and to perform the statistical analysis.

### Experimental Variables & Response Parameter

The capacity of the extraction column (i.e., the amount of material purified per single run) directly related to the amount of extractant on the stationary phase used to prepare the extraction column. The amount of extractant on the stationary phase in turn is mainly influenced by the diffusion of the extractant into the pores of RP-silica particles used as a support. Thus, by improving diffusion of the extractant into the RP-silica pores, it could be possible to enhance the extractant density, thereby maximizing the capacity of the extraction column. In the present invention, therefore, pore size of the RP-silica particles and driving forces of diffusion, namely high temperature and ultrasound were considered as experimental variables. It was also assumed that the capacity of the extraction column can be measured through the extractant density (i.e., the amount of extractant retained by one gram of RP-silica support), which is considered as a response parameter that can be related to the experimental variables.

### Experimental Design

Owing to large number of experimental variables considered, a multi-variate approach using a two-level factorial design (FD) was employed to evaluate the effect of experimental variables on the response parameter (i.e., extractant density). The use of multi-variate approach as opposed to univariate approach, allowed obtaining the combination of the variables, which provided the best response with fewer experiments and could also detect and estimate any interaction between experimental factors. The factorial design was built using Minitab-19 statistical software where the experimental variables were tested at two levels (upper and lower levels). The upper and lower limits were set based on the result of preliminary experiments and limitation placed by the supplier of the RP-silica material used as support. A combination of 8 experiments in duplicate, i.e., a total of 16 runs were performed.

### Procedure

The study was conducted according to the experimental design mentioned-above and procedure described below using HDEHP as a model extractant. Exactly 2.2 grams of narrow-pore or wide-pore RP-silica particles were weighed and transferred into respective 100-mL round bottom flasks each containing 50 mL of extractant HDEHP and a magnetic stirrer. It should be noted that each set of the reaction was a combination of 8 different runs and every reaction was run in duplicate, therefore, a total of 16 reactions.

The reaction setup consisted of a hotplate on which an ultrasonic water bath was mounted. The hot plate supplied heat in controlled manner when needed and the water bath maintained the temperature and served as the ultrasound medium during the reaction time period.

The driving forces studied were temperature and ultrasound. The lower limit of the temperature was room temperature (ca. 20° C.) and the upper limit was set at 60° C. The latter was 10° C. below the maximum operating temperature (i.e., 70° C.) that could be used with RP-silica material according to the specification from the supplier. The lower limit for the ultrasound was 0% (i.e., no sonication) and the upper limit was set to 50% relative output. Higher ultrasound frequency more than 50% relative output was avoided to not damage the reverse-phase of the silica material. The flask was attached to a water condenser to cool the reaction vapors. The content of the reaction flask was stirred at the slowest speed to maintain mixing while preventing damage to the silica surface. The reaction time in all cases was 2 hours. Each of the two replicate reactions were performed in parallel. At the end of the reaction time, where applicable, the heating, ultrasound sonication and/or the stirring was stopped and the reaction material was allowed to settle and cool to room temperature.

The stationary phase preparation mentioned above—that is, containing exactly 2.2 g, each of stationary phase in ca. 50 mL extractant in question—was packed into sixteen 15 cm×4.6 cm-stainless-steel empty column barrels using conventional high-pressure slurry techniques. The extractant in question HDEHP or DOS, which was used as reaction solvent was also used as packing solvent. After the packing was completed, the column was flushed with water at a flow rate of 5 mL/min for at least 2 hours to displace any loosely bound extractant from the columns.

A control column was also packed in 15 cm×4.6 cm stainless-steel empty barrel (the same dimension as the test columns) using a slurry containing exactly 2.2 grams RP-silica in 50 mL of isopropanol employing conventional high-pressure. After the packing, the column was flushed with copious amount of water at the flow rate of 5 mL/min using the HPLC setup to flush out the isopropanol solvent. The control column was needed to determine the void volume and compare the retention behavior of REEs in unmodified RP-column and column packed with the stationary phases prepared according to the present invention.

### Result & Discussion

### Calculation (Capacity Determination)

The capacity of extraction columns packed with the stationary phases prepared according to the above-described procedure were estimated with respect to sorption of La³⁺ (that is, the least retained REE ion with HDEHP) via on-line frontal chromatographic method using the HPLC setup. Prior to the capacity determination, the test columns were pre-conditioned with four column volumes of 0.01 M HNO₃. The La solution 5 mM in 0.01 M HNO₃ was pumped through the pre-conditioned test columns at a constant flowrate of 1 mL/min until the metal breakthrough. The signal from the column effluent was continuously monitored and the breakthrough curves were recorded by means of MP-OES detector at emission line wavelength of 399.575 nm.

The breakthrough volumes (Vb) of the test extraction columns are determined using the respective breakthrough times (in min) by multiplying with the flow rate in (mL/min) as shown in Equation-8.

$$Vb ( mL ) = Tb ( min ) \times u ( mL / min ) \qquad ( Eq - 8 )$$

The void volume (V₀) of the extraction columns was estimated void time to (min) obtained from elution of La through the control column with 3 M HNO₃ as a mobile phase at a flow rate of 1 mL/min using Equation-9. The concentration of the mobile phase (i.e., 3 M HNO₃ solution) was strong enough to give any retention of La ions by the control column that was packed with unmodified RP-silica. The dead volume was determined to be 1 mL and was used for all the test columns.

$$Vo ( mL ) = To ( min ) \times u ( mL / min ) \qquad ( Eq - 9 )$$

The capacities of the test extraction columns (in meq of La³⁺) were calculated using the corresponding breakthrough volumes and the void volume and concentration of the La in the test solution as described by Equation-10.

$$Capacity Extraction column ( meq ) = [ Vb - Vo ] \times Co \times n \qquad ( Eq - 10 )$$

Where: Vb is breakthrough volume in mL; Vo is void volume in mL; Co is concentration of La³⁺ in mmol/mL; and n is the charge of La⁺³.

### Statistical Evaluation

The model matrix of the factorial design consisting of the set of experimental conditions in duplicate is shown in Table-2. The model was fitted with extractant densities obtained using Equations 1-3 as corresponding response values. The fitted model was used to generate ranges of statistical responses to assess the effect of experimental variables (i.e., pore size of RP-silica, high temperature and ultrasound) on the response (i.e., extractant density used as a measure of the capacity of the stationary phases). A Pareto chart was generated to evaluate the significance of the experimental variables on the response (FIG. 1). Response surfaces were also developed by the model and used to locate the conditions of maximum extractant density in the tested domain (FIG. 2).

TABLE 2
The model matrix of the factorial design
and the corresponding response values

| | | | | | | | Extractant |
|---|---|---|---|---|---|---|---|
| Run | Pore Size | | Temperature | | Ultrasound | | Density |
| 1 | Narrow | 100 Å | Low | 20° C. | No | 0% | 12 mmole/g |
| 2 | Wide | 300 Å | Low | 20° C. | No | 0% | 22 mmole/g |
| 3 | Narrow | 100 Å | High | 60° C. | No | 0% | 52 mmole/g |
| 4 | Wide | 300 Å | High | 60° C. | No | 0% | 28 mmole/g |
| 5 | Narrow | 100 Å | Low | 20° C. | Yes | 50% | 58 mmole/g |
| 6 | Wide | 300 Å | Low | 20° C. | Yes | 50% | 30 mmole/g |
| 7 | Narrow | 100 Å | High | 60° C. | Yes | 50% | 92 mmole/g |
| 8 | Wide | 300 Å | High | 60° C. | Yes | 50% | 49 mmole/g |
| 9 | Narrow | 100 Å | Low | 20° C. | No | 0% | 11 mmole/g |
| 10 | Wide | 300 Å | Low | 20° C. | No | 0% | 21 mmole/g |
| 11 | Narrow | 100 Å | High | 60° C. | No | 0% | 51 mmole/g |
| 12 | Wide | 300 Å | High | 60° C. | No | 0% | 29 mmole/g |
| 13 | Narrow | 100 Å | Low | 20° C. | Yes | 50% | 56 mmole/g |
| 14 | Wide | 300 Å | Low | 20° C. | Yes | 50% | 30 mmole/g |
| 15 | Narrow | 100 Å | High | 60° C. | Yes | 50% | 90 mmole/g |
| 16 | Wide | 300 Å | High | 60° C. | Yes | 50% | 50 mmole/g |

As seen in the Pareto chart (FIG. 1), all the experimental parameters studied (i.e., pore size, temperature and ultrasound) showed significant influence on the extractant density of the stationary phase. As seen from the length of respective bars on the chart, however some of the parameters are more important than the others as discussed below.

The invention also is a process for impregnation of the extractant using temperature and ultrasound. As evident from the response values (i.e., extractant densities) in Table-2 and from the surface plots in FIG. 2, the highest extractant density (48.5 mmole/g) was achieved with narrow pore RP-silica and when both ultrasound and high temperature were applied as impregnation driving forces. In contrast, the lowest extractant density (5 mmole/g) was recorded when narrow pore RP-silica was used and none of the deriving forces were applied. The observed difference in the extraction density using the exact same support (narrow phase RP-silica), except for the impregnation driving forces—that is, high temperature and ultrasound—is immense, that is about 750%. Apparently, and without wishing to be bound by theory, application of the driving forces enhance diffusion of the extractant into narrow pores of the RP-silica and access all or most of possible binding sites, which in turn led to higher extractant density.

Stated differently, the present invention relates to narrow pore or wide pore reversed-phase silica, a blend of narrow+wide pore reversed-phase silica; a distribution of reversed-phase silica, for example, a monomodal or a bimodal or a trimodal distribution in terms of pore size of the reversed-phase silica, in which, the impregnation of the extractant is performed under ambient to higher-than-ambient temperature and ultrasonic treatment, as described elsewhere in this disclosure as ultrasound. Particularly, the stationary phase prepared as described herein shows a surprising and multiple times an improvement in extractant density and correspondingly in purification and/or separation of REEs and/or PGMs using extraction chromatography, compared to prior art, which can be used from lab-scale to industrial scale of separation and purification. Particularly, even in the narrow pore range, where the extractant impregnation has been a problem, this invention has addressed that problem and shown a significant improvement in impregnation and density of the extractants.

Except for the pore size, when both or one of the driving forces were applied, the extractant density showed direct correlation with the surface area of the RP-silica in question. Using the exact same conditions where both high temperature and ultrasound, or only high temperature or only ultrasound were used as driving forces, the extractant density for narrow pore RP-silica found to be approximately double as compared to wide pore RP-silica (Table-2). As shown in Table-1, the surface area of narrow pore RP-silica is slightly more than double that of the wide pore RP-silica.

On the other hand, in the absence of driving forces during the impregnation process, the extractant density was found to be much higher for wide pore RP-silica (22 mmole/g) as compared to narrow pore RP-silica (only 12 mmole/g) despite having less than half of the surface area. The observed phenomenon could be due to relatively better diffusion of the extractant into larger pores of the wide pore RP-silica as opposed to far smaller pores of narrow pore RP-silica in absence of the driving forces.

Both the driving forces investigated, that is, the ultrasound and the high temperature, individually and in combination, seem to play a key role in enhancing diffusion of the extractant in the pores of RP-silica and substantially increasing the extractant density thereof, which in turn improves the capacity of the extraction columns. The effect is particularly huge for narrow pore RP-silica, which has more than twice the surface area compared to wide pore RP-silica.

Regardless of the pore size of RP-silica, when only one of the driving forces is used, ultrasound gives slightly better result compared to high temperature. The impregnation conditions showed the highest extractant density in the following order.

Narrow pore RP-silica, high temp, ultrasound>>>narrow pore RP-silica, ultrasound>>narrow pore RP-silica, high temp>>wide pore RP-silica, ultrasound, high temp>wide pore RP-silica, ultrasound>wide pore RP-silica, high temp>wide pore RP-silica, no driving force>narrow pore RP-silica, no driving force.

Stated differently, this invention provides a range of options to select from, for the extractant density desired.

In one embodiment, an extraction column comprises at least one of the following:
(1) narrow pore RP-silica, treated with high temperature and ultrasound;
(2) narrow pore RP-silica, treated with ultrasound;
(3) narrow pore RP-silica, treated with high temperature;
(4) wide pore RP-silica, treated with ultrasound and high temperature;
(5) wide pore RP-silica, treated with ultrasound;
(6) wide pore RP-silica, treated with high temperature; and optionally;
(7) a combination of two or more of the above.

In another embodiment, the invention as described above further comprises (a) wide pore RP-silica, with no impregnation driving force treatment and/or; (b) narrow pore RP-silica, with no impregnation driving force treatment.

Currently, as the art stands, no driving force is applied during the impregnation process. As seen in Table-2 and as discussed above, in the absence of driving forces during the impregnation process, wide pore RP-silica gives better extractant density (about 100% higher) compared to narrow pore RP-silica regardless of having only half of the surface area. The use of high temperature and ultrasound as impregnation driving forces according to this invention led to substantial improvement in extractant density for both wide and narrow pore RP-silica, which are about 227% and 750%, respectively. The improvement according to this invention, from the highest extractant density achieved with the current impregnation method is approximately 410%. The improvement in the extractant density, thereby the capacity of the extraction column accomplished according to this invention is massive and can be a game-changer by enabling extraction chromatography and solid phase extraction methods to compete with or better solvent extraction currently used industrially for separation and purification of REEs and PGMs. To the best of the inventor's knowledge, this has never been tried or reported before.

### SUMMARY

The inherent limitations of extraction chromatography, which are low capacity of the stationary phases and very high cost associated with preparation of extraction columns, has limited its application for industrial-scale separation and purification of metal ions despite its many attractive features including simplicity, speed and environmental friendliness.

This invention substantially improves the capacity of stationary phases used in extraction chromatography and simplifies extraction columns' preparation methodology, thereby eliminating the inherent limitations of the method for large scale production of metal ions, in particular REE and PGM ions.

The capacity of the stationary phase is measured by the amount of material that can be loaded and purified in a single chromatographic run. The amount of material that can be loaded on the stationary phase has a direct dependence on the amount of the extractant on the stationary phase, and the greater the amount of the extractant means the greater the capacity [15]. Hence, the capacity of the stationary phase may be quantified by the amount of extractant present per gram of stationary phase or extractant density.

The effect of different parameters of RP-silica used as a solid support of the stationary phase and different conditions of the impregnation process employed to immobilize the extractant on the solid support on the extractant density have been investigated and resulted in the present invention.

In one embodiment, the result achieved according to this invention led to between 400-700% increases in the extractant density (i.e., capacity of the stationary phases) depending on the type of RP-silica used. The improvement in capacity of stationary phase achieved according to this invention is massive and effectively eliminates the inherent limitation of extraction chromatography and extremely high cost associated with the preparation of extraction columns.

The result could also be a game-changer in large-scale production of REEs and PGMs by bringing extraction chromatography to the field as green and cost-effective alternative method to technically inefficient and/or environmentally unfriendly state-of-the-art solvent extraction and ion-exchange chromatography methods.

### DETAILED DESCRIPTION OF THE SECOND ASPECT OF THE INVENTION

According to the present invention, the REEs and/or the PGMs are separated by means of extraction chromatography, wherein the extraction columns comprise organic compounds with complex forming property (i.e., extractants) physically impregnated on a solid support that can retain the REEs and/or the PGMs by forming complexes of different stability constants with the REE ions or the PGM ions. The REEs and/or the PGMs retained by the extraction column is thereafter eluted by means of a mineral acid as eluent having increasing acid concentration and/or mobile-phase flow-rate.

According to one embodiment of the invention, the extraction column is prepared in a unique way by physically impregnating appropriate extractant on narrow pore or high surface area RP-silica particles. FIG. 1 shows a schematic diagram illustrating the physical impregnation mechanism involving RP-silica as a solid support and HDEHP as a model extractant.

The extraction columns are packed batch wise with slurry of the packing preparation, which consists of RP-silica to which the extractant is immobilized and appropriate organic solvent, preferably the extractant itself as a packing solvent. FIG. 4 illustrates the extraction column packing process.

Aqueous solution of mixed REE salts, except Ce or an aqueous solution of mixed PGM salts are loaded onto the respective extraction columns,

The REE ions, or the PGM complexes are eluted from the loaded column using aqueous solution of mineral acids by isocratic, linear gradient and/or stepwise gradient elution modes and/or eluent flow-rate gradient mode,

The eluted fractions are then concentrated by means of distillation, ion exchange and/or filter membrane filtration techniques to produce more concentrated fractions of individual and/or group of REEs, or PGMs and for eluent recovery and recycling. Other separation techniques, such as azeotropic distillation, centrifugation, evaporation, liquid-liquid extraction, etc. can also be used for eluent recovery and recycling.

It was found out during the present invention that one of the REEs namely, cerium (Ce) reacts differently with the complexing agents investigated. According to the finding, Ce apparently oxidized to higher oxidation state of +4 in the presence of organophosphorus extractants and forms very stable complexes, which could not be eluted from the extraction column in question with mineral acids of maximum concentrations). Hence, it is preferred to deplete Ce by hydrometallurgical methods from the incoming REE mixtures prior to the chromatographic step and use Ce-free REE mixtures as a feed material.

Even though it is possible to separate all REEs or all PGMs in a single chromatographic step, it is preferred for an industrial separation process first to separate an incoming mixture of REEs or PGMs into few sub-groups and thereafter perform a second chromatographic separation where the groups of REEs or PGMs are further separated into the individual REEs or PGMs.

FIG. 5 illustrates a typical flow diagram of a process according to the present invention, where REE concentrates or PGM containing materials obtained from commercial sources are introduced as aqueous feed solution after mineralized in appropriate acid. The choice of acid for mineralization is dependent on the chemistry of the REEs or PGMs, as well as safety and cost considerations. Presently it is assumed that the preferred acids for the REEs are mineral acids such as hydrochloric acid, sulfuric acid, nitric acid, or phosphoric acid. Thus, the REE salts are preferably chlorides, sulfates, nitrates or phosphates. It is also assumed that the preferred acids for the PGMs are hydrochloric acid or aqua-regia (i.e., 3:1 HCl/HNO₃ v/v mixture). Hence, the PGMs are preferably in the form of anionic chloro-complexes thereof.

The skilled person will, however, understand from reading the present description that even other acids/salts may be used. The skilled person will also know how to convert one salt of REEs to another salt, if necessary.

For the REEs, the material to be separated is provided as a REE concentrate, mainly comprising REE salts or oxides. The REE salts or oxides are firstly dissolved in the chosen mineral acid. Thereafter, a further raw material preparation step is performed where a problematic cerium (Ce) is depleted from the mixture of REEs as described above. For simplification of the present description, the invention will be described by using REE nitrate salt and nitric acid. The skilled person will understand that the process using other acids will be the same as when using nitric acid/nitrates.

The Ce depleted REE nitrate salt is introduced into a feed solution system comprising one or more mixing tanks, and a feed solution tank 10. The REE nitrates are dissolved in aqueous nitric acid (HNO₃) solution of about 1 to 1.5 molar concentration to give a concentration of REEs from about 1-100 mg/l, such as e.g. about 50 mg/l, and introduced into the feed liquor tank 10.

For the PGMs, the material to be separated is provided as a PGM containing mineral and scraps of secondary materials, among others obsolete electronic scraps, spent automotive catalytic converters, spent batteries, used electric lamps, super alloys, jewelry scrap, and industrial wastes such as plating solutions and sludge. The PGM containing materials are firstly dissolved in the chosen media as described below.

Owing to their noble nature, the PGMs are often dissolved and stabilized in solution through complexation with appropriate ligands. PGMs are known to form a range of complexes with a variety of different ligands. In technical and commercial perspective, the chloride system is the most cost effective and widely used medium where all of PGMs can be brought into solution and concentrated. Hence, in the present description the invention will be described by using PGM chloro-complexes and aqua-regia (i.e., 3:1 HCl/HNO₃ v/v mixture) as complexation media. The skilled person will understand that the process using other complexing ligands will be the same as when using Aqua-regia.

The mixed PGM chloro-complex solution, with a concentration of PGMs from about 1-100 mg/l, such as e.g. about 50 mg/l, is introduced into one or more feed solution tank 10′.

The aqueous REE-nitrate solution in the feed solution tank 10 is then introduced into a group separation unit 11 via a feed line 12. Similarly, the PGM chloro-complex solution in the feed solution tank 10′ is then introduced to a group separation unit 11′ via a feed line 12′.

The group separation unit comprises one or more liquid chromatography units, comprising large volume high pressure extraction columns each for REEs and PGMs respectively, where the extraction columns comprise appropriate extractants chemically bonded to bare silica particles.

The extractants with complex forming property with the REE ions are preferably an organophosphorus compounds, and that of the PGMs are organic compounds with amine, or sulfur functional groups of the generals formula shown below:

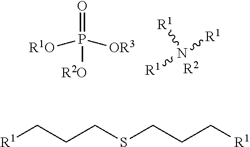

Where R³ is H, or C1-C4 alkyl, and R¹ and R² independently are lipophilic hydrocarbon groups or modified hydrocarbons, such as alkyl, aryl, or ester groups, e.g. having 6 to 20 carbon atoms. Presently preferred complexation agents are di-(2-ethylhexyl) phosphoric acid (HDEHP), di-(2,4,4-trimethylpentyl) phosphinic acid (H[TMPeP]) and 2-ethylhexyl, 2-ethylhexyl phosphonic acid (H[(EH)EHP]), aliquat-336 [N(CH₃)₄], dioctyl sulfide [S(CH₂)₂]. A list of other extractants is provided elsewhere in this disclosure.

The solid support to which the chosen extractant is immobilized is preferably porous RP-silica particle and may be any convenient solid material suitable for liquid chromatography. Presently, the preferred solid support is narrow pore or large surface area porous RP-silica, having a particle size between 5 and 45 μm, and a pore size of 60-100 Å.

The above-mentioned RP-silica may be modified by physically immobilizing desired type of extractant, here described with references to HDEHP, (H[TMPeP]), (H[(EH)EHP]), aliquat-336 [N(CH₃)₄], di-octyl sulfide [S(CH₂)₂]. It is assumed that the extractant is physically bound (for example, by some form of physico-chemical bonding or for example, van der Waals interaction) to the porous RP-silica by bonding between C o nR¹ and R² groups of the extractant and alkyl groups of the RP-silica. The types and different amount of the extractants in the extraction column give different retention capacities, thereby different loading capacity for the different REE and/or PGM ions. The skilled person will easily find which type of extractant and which amount thereof is suitable for the intended separation and purification of REEs or PGMs.

The extraction columns for the separation of REEs and/or PGMs have typically an internal diameter of 600-1200 cm and a bed length of 25-50 cm. The indicated boundaries may, however, be exceeded without departing from the scope of the present invention.

The REE group separation unit or the PGM group separation unit preferably comprises more than one extraction chromatographic columns as described above. The columns are preferably arranged in parallel, and each of them is operated batch wise. The parallel arranged columns may be operated in sequences to allow for a semi-continuous process.

A pre-determined volume/concentration of feed solution containing Ce depleted mixed REEs from tank 10 is loaded onto extraction column 11. Similarly, the mixed PGM chloro-complex solution from tank 10′ is loaded onto extraction column 11′. The acid concentration of both REE or PGM feed solutions is kept in the same level as the initial concentration of the eluent acid and the predetermined volume/concentration of the feed solutions is calculated to be sufficiently below the theoretical capacity of the respective columns (i.e., the amount of extractant in the column) to allow quantitative retention.

After loading, the REEs or the PGMs are eluted from the respective extraction column with appropriate eluent acid and appropriate eluent acid concentration, from an eluent mixing system 20 for the REEs or eluent mixing system for the PGMs. The REE eluent mixing system and the PGM eluent mixing system is capable of mixing incoming streams of water, concentrated acid and recycled acid of different concentrations to deliver the required concentration of eluent, as will be further described below.

The separation of sub-groups of REEs or sub-groups PGMs is normally performed by linear and/or stepwise concentration gradient elution modes, and/or eluent flow gradient elution mode.

The operating extraction column pressure is dependent, among other parameters, on the designed pressure of the column tube, particle size of the inert solid support material, packing density and bed length of the extraction column. In this invention, the operating extraction column pressure during elution of the REEs is typically between 50 to 100 bars.

Extraction columns are normally operated at ambient temperature, but may also be operated at higher temperatures, such as from 20 to 60° C. The preferred extraction column temperature according to this invention is 60° C.

Retention times for the individual REEs or PGMs are very stable and repeatable from one chromatographic run to the next one, provided the concentration of the eluent acid, the elution gradient and the flow-rate of the eluent kept constant. The individual REE or individual PGM fractions may thus be collected based on the retention times. The retention times are, however, preferably checked at a regular basis using metal specific detectors, such as Microwave Plasma Emission Spectrometry (MP-AES). A thin stream split of the eluate leaving the extraction column is introduced to the MP-AES detector, which is capable of qualitatively identifying individual REE or PGM ions.

The separated sub-groups REEs or sub-groups PGMs are collected in dedicated tanks respectively for further processing.

The respective extraction columns are then prepared (pre-conditioned) for the next cycle by flushing with the respective eluent acid solution having about the same acid concentration as the feed solution containing mixture of REEs or PGMs.

The eluted sub-groups of REEs or sub-groups of PGMs from the extraction column respectively are substantially diluted compared to that of the feed solutions loaded onto the respective extraction columns. The eluted sub-groups of REEs or sub-groups of PGMs are therefore preferably concentrated in a concentration and eluent recovery unit, respectively, both to recover and recycle the acid, and to produce a more concentrated fraction for further processing.

Up-concentration of the sub-groups of REE or sub-groups of PGM fractions may be performed in various ways, among others by distillation, ion exchange capture, or using filter membrane, or a combination thereof. The skilled person will understand that each of the separated REE fractions or PGM fractions are concentrated separately, and that the fractions may be concentrated by different methods.

Independent of the method used for up-concentration, the concentrated sub-groups of REE fractions or sub-groups of PGMs fractions are collected in fraction tanks 41, 42 and 43, or 41′, 42′ and 43′, respectively. The concentrated REE fractions or PGM fractions may be further treated at the same facilities, or one or more of the fractions may be converted to other salts, such as carbonates, or respective metals to be settled, dried and finally sold as a final product.

Preferably the REE concentration of sub-groups of REE fractions or the PGM concentration of sub-groups of PGM fractions after up-concentration is 50 to 100 g REE/L nitric acid, or 50 to 100 g PGM/L hydrochloric acid, regardless of the up-concentration method employed.

The group separated and up-concentrated REE fractions in tanks 41, 42, 43 or the group separated and up-concentrated PGM fractions in tanks 41′, 42′, 43′ are thereafter introduced into a single component separation unit 50 or a single component separation unit 50′, respectively. The single component REE separation unit 50 or the single component PGM separation unit 50′ comprises one or more parallel or serially arranged extraction columns for each of the fractions from tanks 41, 42, 43, or tanks 41′, 42′, 43′, respectively. The individual separation of the REEs or the PGMs may be performed using the same extraction columns, respectively as well as the same range of operational parameters described with reference to the group separation unit 11 or unit 11′, respectively.

The loading of the extraction columns in the single component REE separation unit 50, or in the single component PGM separation unit 50′ corresponds to the loading of the extraction columns in unit 11 or unit 11′, respectively. Eluent acid for eluting the individual REEs from the extraction column 50 is mixed in the eluent mixing unit 20 and introduced through an eluent line 51. Similarly, eluent acid for eluting the individual PGMs from the extraction column 50′ is mixed in the eluent mixing unit 20′ and introduced through an eluent line 51′.

The elution of the individual REEs or PGMs from the loaded respective extraction columns is conducted by varying the concentration of the appropriate eluent acid using stepwise or linear concentration gradient modes or, flow gradient mode, or a combination of thereof. The retention times for given acid concentrations are reproducible. MP-AES detection, or corresponding measurements, of a thin stream of the eluate is used to discriminate between the peaks of the individual REEs or PGMs, respectively.

Mixtures of REE or PGM components intended for stockpiling and later separation, are collected in separate eluate tanks, 62, or 62′, respectively. Even though only a few of the eluate tanks are illustrated in FIG. 5, the skilled person will understand that there will be one tank per individual REE or PGM of interest.

The skilled person will also understand that the purity level of any of the individual REE fractions or the individual PGM fractions may be controlled by adjusting the extent of peak overlapping, to produce fractions of a purity according to the specification of the specific costumer. Collection of narrow peak fractions will result in extremely high purity of individual REEs or individual PGMs, such as 99% purity or higher. In cases of both REEs and PGMs, for applications having lower demand on purity, a wider fraction allowing some overlapping with the adjacent fractions may be allowed.

The REE fractions in eluate tanks, 62, or PGM fractions in eluate tank 62′ are substantially diluted compared to the solutions loaded onto the respective extraction columns. Typically, the eluate has a total REE or PGM concentration of 1 to 3 g/L, respectively. The individual REE fractions or PGM fractions are therefore introduced into an up-concentration and eluent recovery unit 70 or unit 70′, respectively, where single component REE fractions or single component PGM fractions are concentrated as described with reference to the eluent recovery unit 40 or 40′, respectively.

The recovered eluent acid from the REE fractions e.g., HNO₃, as described above, is collected in the tanks 25, 26, 27, via lines 25*, 26*, 27*, respectively, according to the acid strength thereof. Similarly, the recovered eluent acid from the PGM fractions e.g., HCl, as described above, is collected in the tanks 25′, 26′, 27′, via lines 25**, 26**, 27**, respectively, according to the acid strength thereof.

The concentrated eluates from REE eluent recovery unit 70 or PGM eluent recovery unit 70′ are collected in concentrate tanks 72, or 72′, respectively.

Overlapping REE peak fractions in tank 61, may be concentrated in the eluent regeneration unit 70, and introduced into a REE recycle tank 90, and may be recycled into the REE group separation unit 11, through line 91, or onto the single REE component separation unit 50.

Similarly, overlapping PGM peak fractions in tank 61′, may be concentrated in the eluent regeneration unit 70′, and introduced into a PGM recycle tank 90′, and may be recycled into the PGM group separation unit 11′, through line 91′, or onto the single PGM component separation unit 50′.

Preferably the REE concentrates in tanks 72 are finally converted to carbonates in a conversion unit 80, by neutralizing with ammonia and addition of carbonic acid or CO₂. The carbonate fractions are dried and collected in carbonate tanks, 82 or may be calcined to give oxides. The separated individual REE carbonates or oxides, and the carbonates from the storage tanks 62 including overlapping peaks of two REEs, or corresponding oxides thereof, may be sold as such to the users thereof for further processing depending on the final use thereof.

Preferably the PGM concentrates in tanks 72′ are finally converted to metallic PGMs in a conversion unit 80′, by reducing with hydrogen gas or other reducing agents. The metallic PGMs are filtered off and collected in storage tank 82′. The separated individual metallic PGMs from the storage tanks 62′ including overlapping peaks of the PGMs may be sold as such to the users thereof for further processing depending on the final use thereof.

The skilled person will understand that for all liquid chromatographic units above, two or more extraction columns may be arranged in parallel, in series, or in a rack setup allowing the operator and/or control system to change the column setup by e.g., changing the sequence of the columns in a series, uncoupling one or more columns to elute the column, and/or to replace extraction columns without disturbing the operation.

### EXAMPLES

### Example 1—Using Different Mineral Acids as Eluent for REEs

Test runs were performed using lab scale extraction columns comprising di-(2-ethylhexyl) phosphoric acid (HDEHP) as extractant and RP-silica as inert solid support for comparing different acids for elution. The acids tested were HNO₃, HCl, H₂SO₄, H₃PO₄. FIG. 6 presents the elution profiles obtained from elution using different mineral acids, and FIG. 7 and FIG. 8 show the difference in retention times and resolution of lighter and SEG REEs using HDEHP column and under the same chromatographic conditions. The REEs shows a minor difference in retention times for all acids, but H₃PO₄ which is not capable of eluting the heaviest REEs.

The remaining three acids show good resolution between the tested REEs but HNO₃ and HCl seems to give a better resolution than H₂SO₄.

A conclusion that may be drawn from these tests, is that HNO₃, HCl and H₂SO₄ are good choices to be used as eluents with a slight preference to HNO₃ and HCl, whereas H₃PO₄ will not be able to eluate all REEs.

### Example 2—Separation of REEs Using Diverse Types of Extractants

Test runs were performed using lab scale extraction columns containing similar amounts, but different types of extractant and under similar chromatographic conditions. FIG. 9 illustrates the elution profiles of lighter and SEG-REEs obtained during the test. Of the three ligands tested, HDEHP gives higher retention capacity for all the REEs investigated followed by (H[TMPeP]) and (H[(EH)EHP]) in that order.

A conclusion that may be drawn from these tests, is that HDEHP is suitable for group separation of all the REEs and individual separation of lighter and SEG-REEs, whereas (H[TMPeP]) may be used for individual separation of early heavy REEs (i.e., Tb−Er)+Y. (H[(EH)EHP]) could be used for individual separation of late heavier REEs (Tm, Yb and Lu)+Sc, which are forming very stable complexes with HDEHP in particular and to lesser extent with (H[TMPeP]).

### Example 3—Separation of REEs as a Function of Amount of Extractant

Test runs were performed using lab scale extraction columns having different amount of HDEHP as extractant (i.e., different extractant density). FIG. 10 illustrates the retention profiles of the REEs obtained from separation of all the REEs under similar chromatographic condition, except the amount of extractant is different. It is apparent from the chromatograms that retention capacities of the extraction column and degree of separation between the adjacent REE peaks are better with higher amount of extractant.

A conclusion that may be drawn from these tests, is that HDEHP is suitable for group separation the REEs and individual separation of most of the REEs (e.g., La−Er+Y), whereas H([HTMeP]) may be used for individual separation of heavier REEs beyond Er (i.e., Tm, Yb, Lu) and Sc, which are forming very stable complexes with HDEHP and difficult to eluted with mineral acids as eluent. H([EHEHP]) might be used for individual and/or group separation of REEs with H₃PO₄ as eluent, which showed weaker eluting capacity as described above.

### Example 4—Separation REEs as a Function of Eluent Flowrate (u)

The effect of eluent flowrate (u) on chromatographic separation of the REEs were tested using lab scale extraction columns comprising HDEHP as extractant and reverse phase silica as inert solid support. A feed solution containing a mixture of several REEs was loaded onto the extraction column and was thereafter eluted with HNO₃ of appropriate concentration by varying the eluent flow rate (u) from 0.5 mL/min to 2 mL/min while keeping the other chromatographic conditions constant. FIGS. 11 and 12 present the peak width (w) of individual REEs and the resolution (Rs) between the adjacent REE peaks, respectively obtained from the test.

The conclusion from this test is that the eluent flowrate (u) of 1.5 mL/min seems to give the best results, i.e., narrow peaks widths for individual REEs and higher resolution between adjacent REE peaks. A flow rate of 1.5 mL/min (i.e., corresponding to a flow rate of 4.3 m³/hour for a column with a diameter of 120 cm), therefore seems to be the optimal flow rate.

### Example 5—Resolution of REEs as a Function of Temperature (T)

The effect of column temperature (T) on chromatographic separation of the REEs were tested using lab scale extraction columns comprising HDEHP as an extractant and reverse phase silica as inert solid support. A feed solution containing a mixture of several REEs was loaded onto the extraction column and was thereafter eluted with HNO₃ of appropriate concentration at the optimum flow rate of 1.5 mL/min by varying the column temperature (T) between 20° C.-60° C. while keeping the other chromatographic conditions constant. FIGS. 13 and 14 present the peak width (w) of individual REEs and the resolution (Rs) between the adjacent REE peaks, respectively obtained from the test.

The conclusion from this test is that higher column temperature gives better results in terms of both peak widths (w) of individual REE peaks and resolution between adjacent REE peaks. Considering maximum temperature allowed when using reverse phase silica which is <70° C., thus a column temperature of 60° C. is chosen as a compromise optimum.

### Example 6—Column Loading Tests for REEs

The column loading tests were conducted using semi-preparative extraction column [1 cm (id)×25 cm (L), 10 μm (pd), 1000 Å (pore size)] packed with reverse phase silica and containing 31 mmole HDEHP. A feed solution containing a mixture of several REEs with a concentration of 46 mg/mL of total REO was used in the test. A series of overloading tests were conducted by injecting 1 mL, 2.5 mL and 5 mL of the feed solution onto the above-mentioned extraction column for low, medium and high loading tests, respectively. Elution was conducted thereafter using appropriate concentration of HNO₃ as eluent and at flow rate of 4 mL/min and column temperature of 60° C., which are found to be optimum parameters according to this invention.

FIG. 15 shows the elution profiles of the REEs at low, medium and high column loading. As seen in the figure, the peak shapes and break-through retention times of individual REEs, as well as resolution between adjacent REE peaks are changing with change in the amount of feed solution loaded onto the column (i.e., extent of loading). Acceptable separation between individual REEs and/or group of REEs is, however, kept even at very high loads.

### Example 7—Group Separation Test of PGMs

FIG. 16 illustrates separation of PGMs as a group from other base metals using DOS extraction column.

### Example 8—Individual Separation Test of PGMs

FIG. 17 illustrates individual separation of Pd from the other PGMs using DOS extraction column.

### Example 9—Individual Separation Test of PGMs

FIG. 18 illustrates individual separation of Rh from the other PGMs using DETA extraction column.

### Example 10—Pilot Scale Separation Tests

Group separation of REEs: Test runs involving group separation of REEs into three sub-groups as light-REEs (La, Pr and Nd), SEG-REEs (Sm, Eu and Gd) heavy-REEs (Tb−Er+Y) was performed using pilot scale extraction column. The column has a dimension of 20 cm (id), 35 cm (L) and packed with narrow pore RP-silica [15 μm (pd) and 100 Å (pore size)] and having an extractant density of 48 mmole HDEHP/g. An incoming Ce depleted mixture of REEs containing 400 mg of TREO was loaded onto the above-mentioned extraction column and eluted with HNO₃ using a combination of concentration and flow gradient elution modes using a column temperature of 60° C. Firstly, a linear gradient elution was conducted from 1.25 M to 3 M HNO₃ for 9 minutes at an eluent flowrate of 800 mL/min to elute the light REEs. This followed by isocratic elution with 7 M HNO₃ for another 9 min at eluent flowrate of 1600 mL/min to elute SEG and heavy REEs. Lastly the column is pre-conditioned with 1.25 M HNO₃ at eluent flowrate of 1600 mL/min for 2 min (after a total of 20 min cycle) and ready for the next group separation cycle. FIG. 19 shows a representative chromatogram and elution profiles from this test.

Individual separation of lighter REEs, except Ce: Test runs involving individual separation of lighter REEs into single components (i.e., La, Pr and Nd) was performed using pilot scale extraction column. The extraction column has a dimension of 20 cm (id), 35 cm (L) and packed with narrow pore RP-silica [15 μm(pd) and 100 Å (pore size) having an extractant density of 48 mmole HDEHP/g. A light REE fraction from the group separation step, after up-concentrated to a desired level of concentration in the distillation/ion-exchange unit, was loaded onto the above-mentioned extraction column and separated in isocratic elution mode with 1.25 M HNO₃ solution at a flowrate of 1.6 L/min and a column temperature of 60° C. FIG. 20 shows a representative chromatogram from this test, where the three light REEs (La, Pr, Nd) are baseline separated and quantitatively eluted from the column within 10 minutes.

Individual separation of SEG REEs: Test runs involving individual separation of SEG REEs into single component was performed using pilot scale extraction column. The column has a dimension of 20 cm (id), 35 cm (L) and packed with narrow pore RP-silica [10 μm(pd) and 100 Å (pore size) having an extractant density of 48 mmole HDEHP/g. A SEG REE fraction from the group separation step, after up-concentrated to a desired level of concentration in the distillation unit, was loaded onto the above-mentioned extraction column and separated by using linear gradient elution mode from initial 1.25 M HNO₃ to final 7 M HNO₃ for 8 mins at a flowrate of 1.6 L/min and a column temperature of 60° C. At the end, the column is pre-conditioned with 1.25 M HNO₃ (the same concentration as the starting concentration of the gradient) for 2 minutes (a total of 10 minutes cycle) at the same flow rate and column temperature indicated above and become ready for the next separation cycle. FIG. 21 shows a representative chromatogram from this test. As seen in the figure, the three SEG REEs (Sm, Eu, Gd) are baseline separated and quantitatively eluted from the column.

Individual Separation of Heavy Early REEs+Y: Test runs involving individual separation of early heavy REEs (Tb, Dy, Ho, Er) and Y was performed using pilot scale extraction column. The column has a dimension of 20 cm (id), 35 cm (L) and packed with narrow pore RP-silica μm(pd) and 100 Å (pore size) having an extractant density of 48 mmoleH ([HTMeP])/g. A fraction containing early heavy REEs (Tb, Dy)+Y obtained from the group separation step, after up-concentrated to a desired level of concentration in the distillation unit, was loaded onto the above-mentioned extraction column and separated using isocratic elution mode with 1.5 M HNO₃ solution at a flowrate of 1.6 L/min and a column temperature of 60° C. FIG. 22 show a representative chromatogram from this test. As apparent in FIG. 19, early heavy REEs (Tb, Dy) and Y are base-line separated and quantitatively eluted from the column within 10 minutes.

Individual Separation of Late Heavy REEs: Test runs involving individual separation of late heavy REEs (Tm, Yb, Lu) was performed using pilot scale extraction column. The column has a dimension of 20 cm (id), 35 cm (L) and packed with RP-silica [15 μm (pd) and 100 Å (pore size) having an extractant density of 48 mmole H([EHEHP])/g. A fraction containing late heavy REEs (Tm, Yb, Lu) obtained from the group separation step, after up-concentrated to a desired level of concentration in the distillation unit, was loaded onto the above-mentioned chromatographic column and separated using isocratic elution mode with 1.25 M HNO₃ solution at a flowrate of 1.6 L/min and a column temperature of 60° C. FIG. 23 shows a representative chromatogram from this test. As seen in Figure, the three heavy REEs in question (Tm, Yb and Lu) are baseline separated and quantitatively eluted from the column within 10 minutes.

1. A stationary phase for chromatographic separation and/or purification of REEs and/or PGMs, said stationary phase comprising an extractant immobilized on a support, wherein:
the support comprises a reverse-phase silica particles characterized by an average pore size less than 2,000 Å,
the extractant comprises an organic compound with complex-forming property capable of retaining and separating REEs and/or PGMs by forming complexes of different stability constants with the different REEs and/or PGMs ions,
wherein the extractant is impregnated into the support at a temperature in the range of 50° C. to 80° C., and/or under an ultrasonic treatment step.

2. The stationary phase as recited in claim 1, wherein the reverse-phase silica particles are characterized by an average pore size less than 300 Å and a surface area greater than 170 m²/g.

3. The stationary phase as recited in claim 1, wherein the reverse-phase silica particles are characterized by an average pore size in the range of 50 Å to 150 Å and a surface area in the range of 200-500 m²/g.

4. The stationary phase as recited in claim 1, wherein the extractant comprises an organophosphorus compound, an amine, a quaternary ammonium salt, a sulfur bearing organic compound, or combinations thereof.

5. The stationary phase as recited in claim 1, wherein the extractant comprises an organophosphorus compound, an amine, a quaternary ammonium salt, a sulfur bearing organic compound, or combinations thereof, with the general formula: 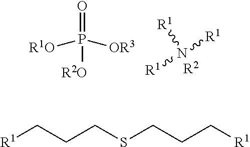
wherein: R¹ and R² independently are lipophilic hydrocarbons or modified hydrocarbons, selected from the group comprising C6-20 alkyl, C6-20 aryl, and R³ is H, C1-C6 alkyl, and C1-C6 aryl.

6. The stationary phase as recited in claim 5 wherein the extractant comprises di-(2-ethylhexyl) phosphoric acid (DHEHP), di-(2,4,4-trimethylpentyl) phosphinic acid (H[TMPeP]) and 2-ethylhexyl, 2-ethylhexyl phosphonic acid (H[(EH)EHP]), aliquat-336 [N(CH₃)₄], dioctyl sulfide [S(CH₂)₂], or a combination thereof.

7. An extraction column for chromatographic separation and/or purification of REEs and/or PGMs, comprising a stationary phase as recited in claims 1-6.

8. A method for preparing the stationary phase for chromatographic separation and/or purification of REEs and/or PGMs, comprising:
(i) providing a support that comprises reverse-phase silica particles characterized by an average pore size less than 2,000 Å,
(ii) impregnating at least one extractant into the reverse-phase silica particles of step 1, wherein the at least one extractant is an organic compound with complex-forming property capable of retaining and separating REEs and/or PGMs by forming complexes of different stability constants with the different REEs and/or PGMs ions,
wherein the extractant is impregnated into the support under at least one of the two conditions, that of a temperature in the range of 50° C. to 80° C.; and that of an ultrasonic treatment step.

9. The method as recited in claim 8, wherein the reverse-phase silica particles are characterized by an average pore size less than 300 Å and a surface area greater than 170 m²/g.

10. The method as recited in claim 8, wherein the reverse-phase silica particles are characterized by an average pore size in the range of 50 Å to 150 Å and a surface area in the range of 200-500 m2/g.

11. The method as recited in claim 8, wherein the extractant comprises an organophosphorus compound, an amine, a quaternary ammonium salt, a sulfur bearing organic compound, or a combinations thereof.

12. The method as recited in claim 8, wherein the extractant comprises an organophosphorus compound, an amine, a quaternary ammonium salt, a sulfur bearing organic compound, or a combinations thereof, with the general formula: 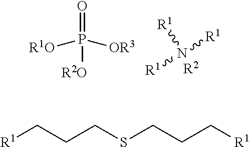
wherein: R¹ and R² independently are lipophilic hydrocarbons or modified hydrocarbons, selected from the group comprising C6-20 alkyl, C6-20 aryl, and R³ is H, C1-C6 alkyl, and C1-C6 aryl.

13. The method as recited in claim 12, wherein the extractant comprises di-(2-ethylhexyl) phosphoric acid (DHEHP), di-(2,4,4-trimethylpentyl) phosphinic acid (H[TMPeP]) and 2-ethylhexyl, 2-ethylhexyl phosphonic acid (H[(EH)EHP]), aliquat-336 [N(CH₃)₄], dioctyl sulfide [S(CH₂)₂], or a combination thereof.

14. A method for separating and/or purifying REEs and/or PGMs, from an aqueous solution comprising REEs and/or PGMs, said method comprising the steps of:
(a) providing the extraction column as recited in claims 1-7;
(b) loading the aqueous solution comprising REEs and/or PGMs onto the extraction column;
(c) using an eluent mode to separate REEs and/or PGMs; and
(d) eluting the separated REES and/or PGMs from the extraction column.

15. The method as recited in claim 14, wherein the eluent mode is an eluent concentration mode and/or an eluent flow-rate gradient mode, and optionally, the eluting step is performed by:
(i) an isocratic concentration of an eluent mineral acid in said aqueous solution,
(ii) a linear gradient concentration of said eluent mineral acid in said aqueous solution, or
(iii) a step-wise gradient of concentration of said eluent mineral acid in said aqueous solution.

16. The method as recited in claim 14, further comprising at least one of the following steps:
(e) collecting a fraction of eluate comprising the REEs and/or PGMs;
(f) up-concentrating the eluted the REEs and/or PGMs fraction; and
(g) recovering the eluent mineral acid and water.

17. The method as recited in claim 14, wherein the elution and collection of fractions in steps d and e are controlled in a manner to collect the REEs and/or PGMs having similar retention capacities on a given extraction column from the one or more than one extraction column.

18. The method of claim 14, wherein the REEs and/or PGMs solution loaded onto the column has an acid matrix allowing the REEs and/or PGMs to be quantitatively retained by the given column.

19. The method according to claim 18, wherein the quantitatively retained REEs and/or PGMs are REEs and are eluted with an eluent having increasing acid concentration and/or eluent flow-rate to first elute a light-REE group, thereafter a SEG-REE group, and thereafter a heavy REE+Y group.

20. The method according to claim 19, wherein:
(i) the light-REE group is completely absent or comprises at least one of La, Pr, and Nd,
(ii) the SEG-REE group is completely absent or comprises at least one of Sm, Eu, and Gd; and
(iii) the heavy REE+Y group is completely absent or comprises at least one of Tb, Dy, Ho, Er, Tm, Yb, Lu, and Y;
and wherein at least one of the three groups from (i), (ii), and (iii) is present.

21. The method according to claim 18, wherein the REES and/or PGMs comprises PGMs, wherein said PGMs are quantitatively retained and are eluted with an eluent having increasing acid concentration and/or eluent flow-rate, wherein:
(i) a primary group PGMs comprising at least one of Pd and Pt is eluted first and,
(ii) a secondary group PGMs comprising at least one of Rh, Ru and Ir is eluted second.

22. The method of claim 16, wherein the elution and collection of fractions in step d and/or e is controlled to collect substantially pure fractions of individual metals from the REEs and/or PGMs.

23. The method as recited in claim 14, wherein fractions containing group of REEs, individual REEs, group of PGMs, or PGMs are collected, and concentrated to recover eluent by distillation, ion-exchange, membrane filtration, centrifugation, solvent extraction, evaporation, or a combination thereof.

24. The method as recited in claim 14, wherein one or more of the concentrated fractions are converted to insoluble salts, oxides or metals, which are individually collected and dried.

25. The method as recited in claim 14, wherein the elution is performed under a pressure between 50 and 100 bar.

26. The method as recited in claim 14, wherein the aqueous solution is acidic.

27. The method according to claim 14, wherein the quantitatively retained REEs are eluted with an eluent having increasing acid concentration and or eluent flow-rate to first elute a light-REE group mainly comprising La, Pr and Nd and, thereafter a SEG-REE group comprising Sm, Eu and Gd and a heavy REE+Y group mainly comprising Tb, Dy, Ho, Er, Tm, Yb, Lu and Y.

28. The method according to claim 14, wherein the quantitatively retained PGMs are eluted with an eluent having increasing acid concentration and or eluent flow-rate to first elute a primary group PGMs comprising Pd and Pt and, thereafter a secondary group PGMs comprising Rh, Ru and Ir.

29. The method of claim 14, wherein the elution and collection of fractions is controlled to collect substantially pure fractions of individual REEs or PGMs.

30. A method for industrial separation and purification of individual REEs and/or PGMs from an aqueous mixed REEs and/or PGMs solution, wherein, from an incoming solution comprising mixed REEs and/or PGMs:
(i) the REEs and/or PGMs are first separated into sub-groups, of REEs and PGMs, by the method according to any of the claims 15-21, and
(ii) one or more of the sub-groups of REEs and/or PGMs thereafter are separated according to claim 22.
